(19) United States
(12) Patent Application Publication
(10) Pub. No.: US 2006/0196778 A1
(43) Pub. Date: Sep. 7, 2006

(54) Tungsten electroprocessing

(76) Inventors: Renhe Jia, Berkeley, CA (US); Zhihong Wang, Santa Clara, CA (US); Yuan Tian, San Jose, CA (US); Huyen Karen Tran, Sunnyvale, CA (US); Daxin Mao, Cupertino, CA (US); Stan Tsai, Fremont, CA (US); Lakshmanan Karuppiah, San Jose, CA (US); Liang-Yuh Chen, Foster City, CA (US)

Correspondence Address: PATTERSON & SHERIDAN, LLP, 3040 POST OAK BOULEVARD, SUITE 1500, HOUSTON, TX, 77056, US

(21) Appl. No.: 11/342,179

(22) Filed: Jan. 27, 2006

Related U.S. Application Data
(60) Provisional application No. 60/647,944, filed on Jan. 28, 2005.

(51) Int. Cl. B23H 9/00; C25D 17/00

(52) U.S. Cl. 205/640; 204/224 M

(57) ABSTRACT

Methods for polishing tungsten are provided. During ECMP, increasing the voltage to the pad is not always enough to increase the polishing rate. When polishing tungsten, simply increasing the applied voltage will, in some cases, actually decrease the removal rate. By increasing the down force pressure between the polishing pad and the substrate, the applied voltage, and the rotation speed of the substrate and the polishing pad, the tungsten removal rate will also increase.

### CROSS-REFERENCE TO RELATED APPLICATIONS

This application claims benefit of U.S. provisional patent application Ser. No. 60/647,944, filed Jan. 28, 2005, which is herein incorporated by reference.

### BACKGROUND OF THE INVENTION

1. Field of the Invention

Embodiments of the present invention relate to methods for removing tungsten from a substrate.

2. Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process in which material is removed from the surface of the substrate to form a generally even, planar surface. Planarization is useful in removing excess deposited material, removing undesired surface topography, and surface defects, such as surface roughness, agglomerated materials, crystal lattice damage, scratches, and contaminated layers or materials to provide an even surface for subsequent photolithography and other semiconductor manufacturing processes.

It is extremely difficult to planarize a metal surface, particularly a tungsten surface, as by chemical mechanical polishing (CMP), which planarizes a layer by chemical activity as well as mechanical activity, of a damascene inlay as shown in FIGS. 1A and 1B, with a high degree of surface planarity. A damascene inlay formation process may include etching feature definitions in an interlayer dielectric, such as a silicon oxide layer, sometimes including a barrier layer in the feature definition and on a surface of the substrate, and depositing a thick layer of tungsten material on the barrier layer and substrate surface. Chemical mechanically polishing the tungsten material to remove excess tungsten above the substrate surface often insufficiently planarizes the tungsten surface. Chemical mechanical polishing techniques to completely remove the tungsten material often results in topographical defects, such as dishing and erosion, that may affect subsequent processing of the substrate.

Dishing occurs when a portion of the surface of the inlaid metal of the interconnection formed in the feature definitions in the interlayer dielectric is excessively polished, resulting in one or more concave depressions, which may be referred to as concavities or recesses. Referring to FIG. 1A, a damascene inlay of conductive lines 11 and 12 are formed by depositing a metal, such as tungsten (W) or a tungsten alloy, in a damascene opening formed in interlayer dielectric 10, for example, silicon dioxide. While not shown, a barrier layer of a suitable material such as titanium and/or titanium nitride for tungsten may be deposited between the interlayer dielectric 10 and the inlaid metal 12. Subsequent to planarization, a portion of the inlaid metal 12 may be depressed by an amount D, referred to as the amount of dishing. Dishing is more likely to occur in wider or less dense features on a substrate surface.

Conventional planarization techniques also sometimes result in erosion, characterized by excessive polishing of the layer not targeted for removal, such as a dielectric layer surrounding a metal feature. Referring to FIG. 1B, a metal line 21 and dense array of metal lines 22 are inlaid in interlayer dielectric 20. Polishing the metal lines 22 may result in loss, or erosion E, of the dielectric 20 between the metal lines 22. Erosion is observed to occur near narrower or more dense features formed in the substrate surface. Modifying conventional tungsten CMP polishing techniques has resulted in less than desirable polishing rates and polishing results than commercially acceptable.

Therefore, there is a need for compositions and methods for removing conductive material, such as excess tungsten material, from a substrate that minimizes the formation of topographical defects to the substrate during planarization.

### SUMMARY OF THE INVENTION

Aspects of the invention provide compositions and methods for removing conductive materials by an electrochemical polishing technique. In one aspect, a composition is provided for removing at least a tungsten material from a substrate surface including between about 0.2 vol % and about 5 vol % of sulfuric acid or derivative thereof, between about 0.2 vol % and about 5 vol % of phosphoric acid or derivative thereof, between about 0.1 wt % and about 5 wt % of citrate salt, a pH adjusting agent to provide a pH between about 3 and about 8, and a solvent.

In a first embodiment, a method for polishing tungsten is disclosed. The method involves providing an ECMP apparatus. The apparatus has a rotatable platen with a polishing pad thereon. A wafer is provided with a tungsten layer thereon. The wafer is provided on a rotatable polishing head. A voltage is applied to the polishing pad. Both the platen and polishing head are rotated. The tungsten layer is contacted with the polishing pad to create a down force pressure and a current density on the wafer. A polishing slurry is provided between the polishing pad and the tungsten layer. The tungsten layer is then polished. The rate of polishing is controlled by controlling the rotation rate of both the platen and the polishing head, by controlling the down force pressure, and by controlling the current density.

In a second embodiment of the invention, a method for polishing tungsten is disclosed. The method involves providing a polishing pad on a rotatable polishing platen; providing a rotatable polishing head; providing a 300 mm diameter wafer on the polishing head; pressing the wafer against the polishing pad to create a downforce pressure; rotating the platen; rotating the polishing head; applying a voltage to the polishing pad to create a current density on the wafer during polishing; and controlling the polishing by controlling a rotation rate of both the pad and the wafer, controlling the current density, and controlling the downforce pressure to remove the tungsten at a rate of about 600 to about 2000 Å/min. The wafer comprises a tungsten layer.

The third embodiment of the invention involves a method for increasing a polishing rate for tungsten. The method involves providing a rotatable polishing head with a wafer having a tungsten thereon; providing a rotatable platen with a polishing pad thereon; applying a voltage to the platen; and controlling a rotation rate of both the pad and the wafer, controlling a current density applied to the wafer, and controlling a downforce pressure between the pad and the wafer.

### BRIEF DESCRIPTION OF THE DRAWINGS

So that the manner in which the above recited aspects of the present invention are attained and can be understood in detail, a more particular description of embodiments of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B schematically illustrate the phenomenon of dishing and erosion respectively;

FIG. 2 is a plan view of an electrochemical mechanical planarizing system;

FIG. 3 is a sectional view of one embodiment of a first electrochemical mechanical planarizing (ECMP) station of the system of FIG. 2;

FIG. 4A is a partial sectional view of the first ECMP station through two contact assemblies;

FIGS. 4B-C are sectional views of alternative embodiments of contact assemblies;

FIGS. 4D-E are sectional views of plugs;

FIGS. 5A and 5B are side, exploded and sectional views of one embodiment of a contact assembly;

FIG. 6 is one embodiment of a contact element;

FIG. 7 is a vertical sectional view of another embodiment of an ECMP station; and

FIGS. 8A-8D are schematic cross-sectional views illustrating a polishing process performed on a substrate according to one embodiment.

FIG. 9 is a flow diagram of one embodiment of a method for electroprocessing conductive and barrier materials;

FIG. 10 depicts a graph illustrating current and voltage traces verse time for one embodiment of an exemplary electroprocessing method; and

FIGS. 11-14 depict graphs and text illustrating the relationship between voltage and removal rate, and the effect of pressure and velocity thereon.

To facilitate understanding, identical reference numerals have been used, where possible, to designate identical elements that are common to the figures.

### DETAILED DESCRIPTION OF THE PREFERRED EMBODIMENT

In general, aspects of the invention provide compositions and methods for removing at least a tungsten material from a substrate surface. The invention is described below in reference to a planarizing process for the removal of tungsten materials from a substrate surface by an electrochemical mechanical polishing (ECMP) technique.

The words and phrases used herein should be given their ordinary and customary meaning in the art by one skilled in the art unless otherwise further defined. Chemical polishing should be broadly construed and includes, but is not limited to, planarizing a substrate surface using chemical activity. Electropolishing should be broadly construed and includes, but is not limited to, planarizing a substrate by the application of electrochemical activity. Electrochemical mechanical polishing (ECMP) should be broadly construed and includes planarizing a substrate by the application of electrochemical activity, mechanical activity, and chemical activity to remove material from a substrate surface.

Anodic dissolution should be broadly construed and includes, but is not limited to, the application of an anodic bias to a substrate directly or indirectly which results in the removal of conductive material from a substrate surface and into a surrounding polishing composition. Polishing composition should be broadly construed and includes, but is not limited to, a composition that provides ionic conductivity, and thus, electrical conductivity, in a liquid medium, which generally comprises materials known as electrolyte components. The amount of each electrolyte component in polishing compositions can be measured in volume percent or weight percent. Volume percent refers to a percentage based on volume of a desired liquid component divided by the total volume of all of the liquid in the complete solution. A percentage based on weight percent is the weight of the desired component divided by the total weight of all of the liquid components in the complete solution.

Apparatus

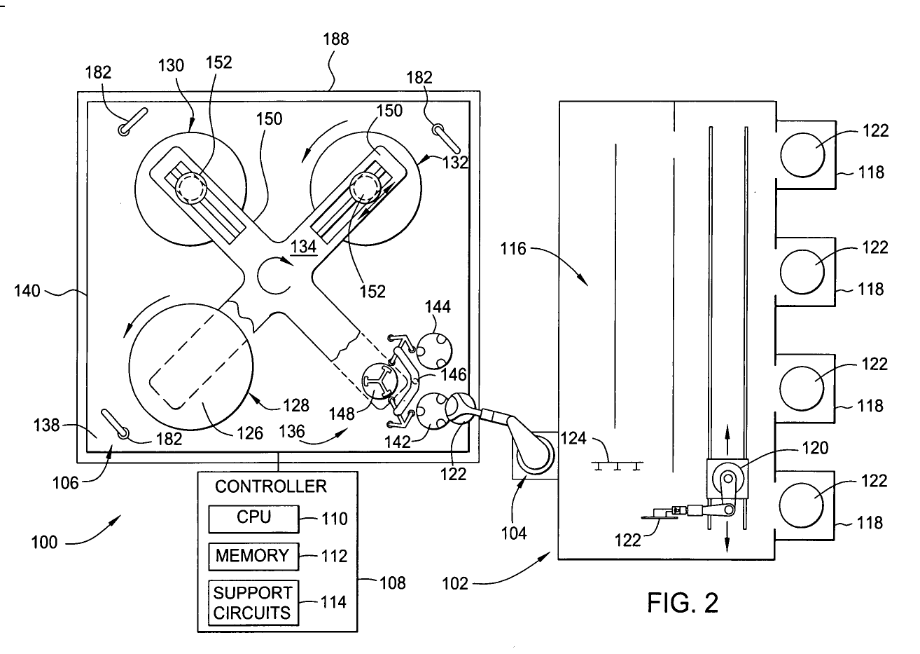

FIG. 2 is a plan view of one embodiment of a planarization system 100 having an apparatus for electrochemically processing a substrate. The exemplary system 100 generally comprises a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the system 100. The controller 108 comprises a central processing unit (CPU) 110, a memory 112, and support circuits 114. The controller 108 is coupled to the various components of the system 100 to facilitate control of, for example, the planarizing, cleaning, and transfer processes.

The factory interface 102 generally includes a cleaning module 116 and one or more wafer cassettes 118. An interface robot 120 is employed to transfer substrates 122 between the wafer cassettes 118, the cleaning module 116 and an input module 124. The input module 124 is positioned to facilitate transfer of substrates 122 between the planarizing module 106 and the factory interface 102 by grippers, for example vacuum grippers or mechanical clamps (not shown).

The planarizing module 106 includes at least a first electrochemical mechanical planarizing (ECMP) station 128, disposed in an environmentally controlled enclosure 188. Examples of planarizing modules 106 that can be adapted to benefit from the invention include MIRRA®, MIRRA MESA™, REFLEXION®, REFLEXION® LK, and REFLEXION LK ECMP™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

In the embodiment depicted in FIG. 2, the planarizing module 106 includes the first ECMP station 128, a second ECMP station 130 and a third ECMP station 132. Bulk removal of conductive material disposed on the substrate 122 may be performed through an electrochemical dissolution process at the first ECMP station 128. After the bulk material removal at the first ECMP station 128, the remaining conductive material may be removed from the substrate at the second ECMP station 130 through a multi-step electrochemical mechanical process, wherein part of the multi-step process is configured to remove residual conductive material. It is contemplated that more than one ECMP station may be utilized to perform the multi-step removal process after the bulk removal process performed at a different station. Alternatively, each of the first and second ECMP stations 128, 130 may be utilized to perform both the bulk and multi-step conductive material removal on a single station. It is also contemplated that all ECMP stations (for example 3 stations of the module 106 depicted in FIG. 2) may be configured to process the conductive layer with a two step removal process.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

The carousel 134 is centrally disposed on the base 140. The carousel 134 typically includes a plurality of arms 150, each supporting a planarizing head assembly 152. Two of the arms 150 depicted in FIG. 2 are shown in phantom such that the transfer station 136 and a planarizing surface 126 of the first ECMP station 128 may be seen. The carousel 134 is indexable such that the planarizing head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

A conditioning device 182 is disposed on the base 140 adjacent each of the planarizing stations 128, 130, and 132. The conditioning device 182 periodically conditions the planarizing material disposed in the stations 128, 130, 132 to maintain uniform planarizing results.

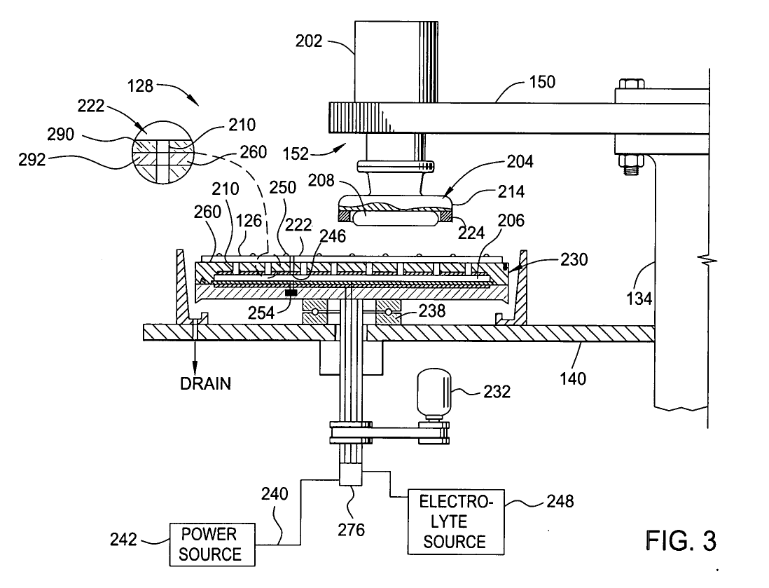

FIG. 3 depicts a sectional view of one of the planarizing head assemblies 152 positioned over one embodiment of the first ECMP station 128. The second and third ECMP stations 130, 132 may be similarly configured. The planarizing head assembly 152 generally comprises a drive system 202 coupled to a planarizing head 204. The drive system 202 generally provides at least rotational motion to the planarizing head 204. The planarizing head 204 additionally may be actuated toward the first ECMP station 128 such that the substrate 122 retained in the planarizing head 204 may be disposed against the planarizing surface 126 of the first ECMP station 128 during processing. The drive system 202 is coupled to the controller 108 that provides a signal to the drive system 202 for controlling the rotational speed and direction of the planarizing head 204.

In one embodiment, the planarizing head may be a TITAN HEAD™ or TITAN PROFILER™ wafer carrier manufactured by Applied Materials, Inc. Generally, the planarizing head 204 comprises a housing 214 and retaining ring 224 that defines a center recess in which the substrate 122 is retained. The retaining ring 224 circumscribes the substrate 122 disposed within the planarizing head 204 to prevent the substrate from slipping out from under the planarizing head 204 while processing. The retaining ring 224 can be made of plastic materials such as polyphenylene sulfide (PPS), polyetheretherketone (PEEK), and the like, or conductive materials such as stainless steel, Cu, Au, Pd, and the like, or some combination thereof. It is further contemplated that a conductive retaining ring 224 may be electrically biased to control the electric field during ECMP. Conductive or biased retaining rings tend to slow the polishing rate proximate the edge of the substrate. It is contemplated that other planarizing heads may be utilized.

The first ECMP station 128 generally includes a platen assembly 230 that is rotationally disposed on the base 140. The platen assembly 230 is supported above the base 140 by a bearing 238 so that the platen assembly 230 may be rotated relative to the base 140. An area of the base 140 circumscribed by the bearing 238 is open and provides a conduit for the electrical, mechanical, pneumatic, control signals and connections communicating with the platen assembly 230.

Conventional bearings, rotary unions and slip rings, collectively referred to as rotary coupler 276, are provided such that electrical, mechanical, fluid, pneumatic, control signals and connections may be coupled between the base 140 and the rotating platen assembly 230. The platen assembly 230 is typically coupled to a motor 232 that provides the rotational motion to the platen assembly 230. The motor 232 is coupled to the controller 108 that provides a signal for controlling for the rotational speed and direction of the platen assembly 230.

A top surface 260 of the platen assembly 230 supports a processing pad assembly 222 thereon. The processing pad assembly may be retained to the platen assembly 230 by magnetic attraction, vacuum, clamps, adhesives and the like.

A plenum 206 is defined in the platen assembly 230 to facilitate uniform distribution of electrolyte to the planarizing surface 126. A plurality of passages, described in greater detail below, are formed in the platen assembly 230 to allow electrolyte, provided to the plenum 206 from an electrolyte source 248, to flow uniformly though the platen assembly 230 and into contact with the substrate 122 during processing. It is contemplated that different electrolyte compositions may be provided during different stages of processing.

The processing pad assembly 222 includes an electrode 292 and at least a planarizing portion 290. The electrode 292 is typically comprised of a conductive material, such as stainless steel, copper, aluminum, gold, silver and tungsten, among others. The electrode 292 may be solid, impermeable to electrolyte, permeable to electrolyte or perforated. At least one contact assembly 250 extends above the processing pad assembly 222 and is adapted to electrically couple the substrate being processed on the processing pad assembly 222 to the power source 242. The electrode 292 is also coupled to the power source 242 so that an electrical potential may be established between the substrate and electrode 292.

A meter 240 is provided to detect a metric indicative of the electrochemical process. The meter may be coupled or positioned between the power source 242 and at least one of the electrode 292 or contact assembly 250. The meter may also be integral to the power source 242. In one embodiment, the meter is configured to provide the controller 108 with a metric indicative of processing, such as charge, current and/or voltage. This metric may be utilized by the controller 108 to adjust the processing parameters in-situ or to facilitate endpoint or other process stage detection.

A window 246 is provided through the pad assembly 222 and/or platen assembly 230, and is configured to allow a sensor 254, positioned below the pad assembly 222, to sense a metric indicative of polishing performance. For example, the sensor 254 may be an eddy current sensor or an interferometer, among other sensors. The metric, provided by the sensor 254 to the controller 108, provides information that may be utilized for processing profile adjustment in-situ, endpoint detection or detection of another point in the electrochemical process. In one embodiment, the sensor 254 an interferometer capable of generating a collimated light beam, which during processing, is directed at and impinges on a side of the substrate 122 that is being polished. The interference between reflected signals is indicative of the thickness of the conductive layer of material being processed. One sensor that may be utilized to advantage is described in U.S. Pat. No. 5,893,796, issued Apr. 13, 1999, to Birang, et al., which is hereby incorporated by reference in its entirety.

Embodiments of the processing pad assembly 222 suitable for removal of conductive material from the substrate 122 may generally include a planarizing surface 126 that is substantially dielectric. Other embodiments of the processing pad assembly 222 suitable for removal of conductive material from the substrate 122 may generally include a planarizing surface 126 that is substantially conductive. At least one contact assembly 250 is provided to couple the substrate to the power source 242 so that the substrate may be biased relative to the electrode 292 during processing. Apertures 210, formed through the planarizing layer 290 and the electrode 292 and any elements disposed below the electrode, allow the electrolyte to establish a conductive path between the substrate 112 and electrode 292.

In one embodiment, the planarizing portion 290 of the processing pad assembly 222 is a dielectric, such as polyurethane. Examples of processing pad assemblies that may be adapted to benefit from the invention are described in United States Patent Publication No. 2004/0023610 A1, published Feb. 5, 2004, entitled “Conductive Polishing Article For Electrochemical Mechanical Polishing”, and United States Patent Publication No. 2004/0020789 A1, published Feb. 5, 2004, entitled “Conductive Polishing Article For Electrochemical Mechanical Polishing,” both of which are hereby incorporated by reference in their entireties.

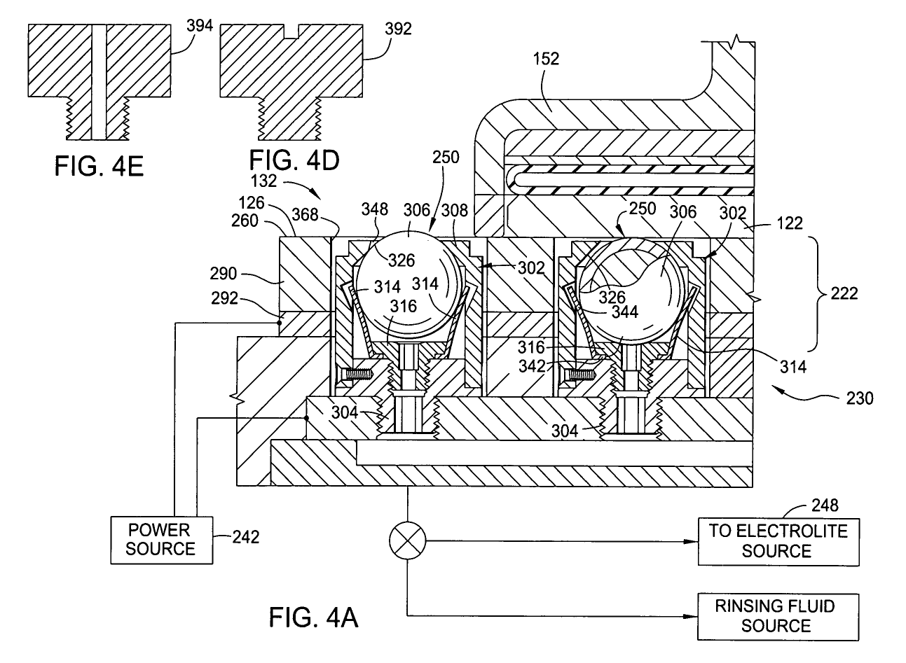

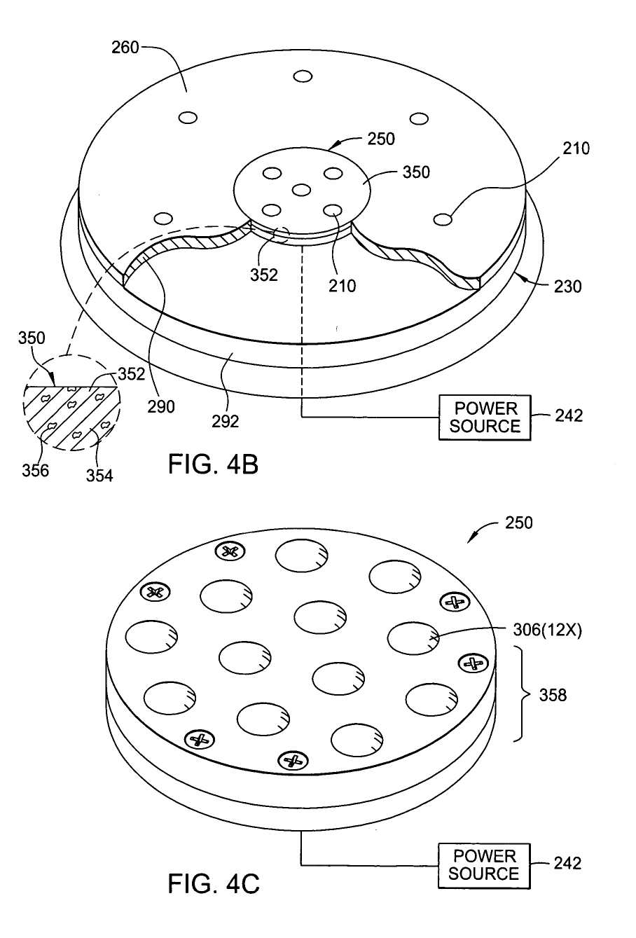

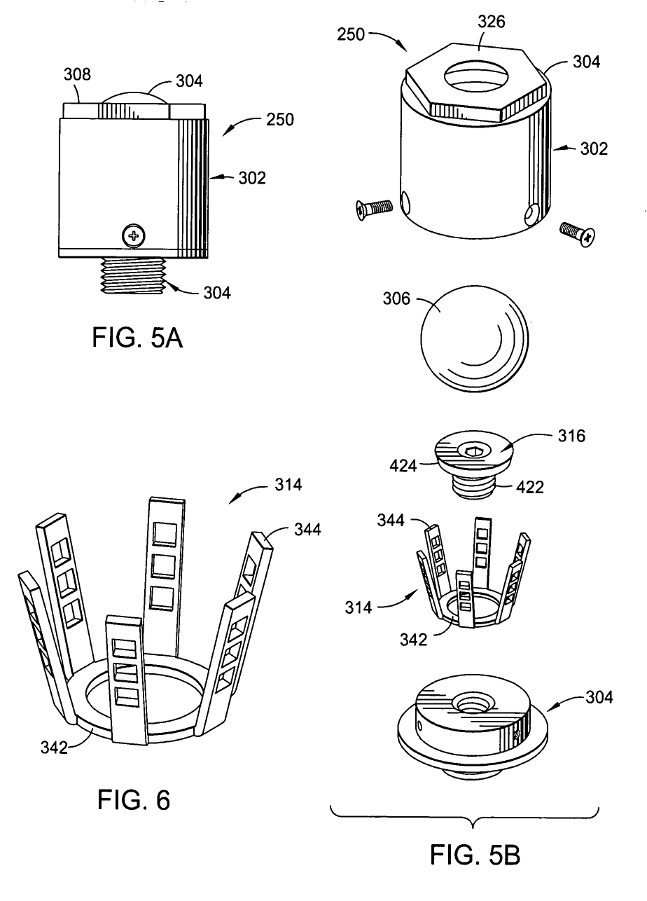

FIG. 4A is a partial sectional view of the first ECMP station 128 through two contact assemblies 250, and FIGS. 5A-C are side, exploded and sectional views of one of the contact assemblies 250 shown in FIG. 5A. The platen assembly 230 includes at least one contact assembly 250 projecting therefrom and coupled to the power source 242 that is adapted to bias a surface of the substrate 122 during processing. The contact assemblies 250 may be coupled to the platen assembly 230, part of the processing pad assembly 222, or a separate element. Although two contact assemblies 250 are shown in FIG. 3A, any number of contact assemblies may be utilized and may be distributed in any number of configurations relative to the centerline of the platen assembly 230.

The contact assemblies 250 are generally electrically coupled to the power source 242 through the platen assembly 230 and are movable to extend at least partially through respective apertures 368 formed in the processing pad assembly 222. The positions of the contact assemblies 250 may be chosen to have a predetermined configuration across the platen assembly 230. For predefined processes, individual contact assemblies 250 may be repositioned in different apertures 368, while apertures not containing contact assemblies may be plugged with a stopper 392 or filled with a nozzle 394 (as shown in FIGS. 4D-E) that allows flow of electrolyte from the plenum 206 to the substrate. One contact assembly that may be adapted to benefit from the invention is described in U.S. Pat. No. 6,884,153, issued Apr. 26, 2005, by Manens, et al., and is hereby incorporated by reference in its entirety.

Although the embodiments of the contact assembly 250 described below with respect to FIG. 3A depicts a rolling ball contact, the contact assembly 250 may alternatively comprise a structure or assembly having a conductive upper layer or surface suitable for electrically biasing the substrate 122 during processing. For example, as depicted in FIG. 4B, the contact assembly 250 may include a pad structure 350 having an upper layer 352 made from a conductive material or a conductive composite (i.e., a conductive material is dispersed with another material at the upper surface), such as a polymer matrix 354 having conductive particles 356 dispersed therein or a conductive coated fabric, among others. The pad structure 350 may include one or more of the apertures 210 formed therethrough for electrolyte delivery to the upper surface of the pad assembly. Other examples of suitable contact assemblies are described in United States Patent Publication No. 2005/0092621 A1 published May 5, 2005, by Hu, et al., which is hereby incorporated by reference in there entireties.

In one embodiment, each of the contact assemblies 250 includes a hollow housing 302, an adapter 304, a ball 306, a contact element 314 and a clamp bushing 316. The ball 306 has a conductive outer surface and is movably disposed in the housing 302. The ball 306 may be disposed in a first position having at least a portion of the ball 306 extending above the planarizing surface 126 and at least a second position where the ball 306 is substantially flush with the planarizing surface 126. It is also contemplated that the ball 306 may move completely below the planarizing surface 126. The ball 306 is generally suitable for electrically coupling the substrate 122 to the power source 242. It is contemplated that a plurality of balls 306 for biasing the substrate may be disposed in a single housing 358 as depicted in FIG. 4C.

The power source 242 generally provides a positive electrical bias to the ball 306 during processing. Between planarizing substrates, the power source 242 may optionally apply a negative bias to the ball 306 to minimize attack on the ball 306 by process chemistries.

The housing 302 is configured to provide a conduit for the flow of electrolyte from the source 248 to the substrate 122 during processing. The housing 302 is fabricated from a dielectric material compatible with process chemistries. A seat 326 formed in the housing 302 prevents the ball 306 from passing out of the first end 308 of the housing 302. The seat 326 optionally may include one or more grooves 348 formed therein that allow fluid flow to exit the housing 302 between the ball 306 and seat 326. Maintaining fluid flow past the ball 306 may minimize the propensity of process chemistries to attack the ball 306.

The contact element 314 is coupled between the clamp bushing 316 and the adapter 304. The contact element 314 is generally configured to electrically connect the adapter 304 and ball 306 substantially or completely through the range of ball positions within the housing 302. In one embodiment, the contact element 314 may be configured as a spring form.

In the embodiment depicted in FIGS. 4A-E and 5A-C and detailed in FIG. 6, the contact element 314 includes an annular base 342 having a plurality of flexures 344 extending therefrom in a polar array. The flexure 344 is generally fabricated from a resilient and conductive material suitable for use with process chemistries. In one embodiment, the flexure 344 is fabricated from gold plated beryllium copper.

Returning to FIGS. 4A and 5A-B, the clamp bushing 316 includes a flared head 424 having a threaded post 422 extending therefrom. The clamp bushing 316 may be fabricated from either a dielectric or conductive material, or a combination thereof, and in one embodiment, is fabricated from the same material as the housing 302. The flared head 424 maintains the flexures 344 at an acute angle relative to the centerline of the contact assembly 250 so that the flexures 344 of the contact elements 314 are positioned to spread around the surface of the ball 306 to prevent bending, binding and/or damage to the flexures 344 during assembly of the contact assembly 250 and through the range of motion of the ball 306.

The ball 306 may be solid or hollow and is typically fabricated from a conductive material. For example, the ball 306 may be fabricated from a metal, conductive polymer or a polymeric material filled with conductive material, such as metals, conductive carbon or graphite, among other conductive materials. Alternatively, the ball 306 may be formed from a solid or hollow core that is coated with a conductive material. The core may be non-conductive and at least partially coated with a conductive covering.

The ball 306 is generally actuated toward the planarizing surface 126 by at least one of spring, buoyant or flow forces. In the embodiment depicted in FIG. 5, flow through the passages formed through the adapter 304 and clamp bushing 316 and the platen assembly 230 from the electrolyte source 248 urge the ball 306 into contact with the substrate during processing.

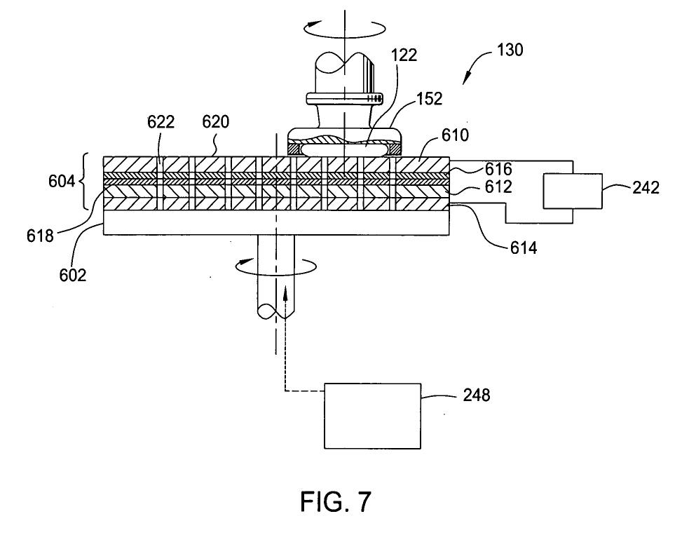

FIG. 7 is a sectional view of one embodiment of the second ECMP station 130. The first and third ECMP stations 128, 132 may be configured similarly. The second ECMP station 130 generally includes a platen 602 that supports a fully conductive processing pad assembly 604. The platen 602 may be configured similar to the platen assembly 230 described above to deliver electrolyte through the processing pad assembly 604, or the platen 602 may have a fluid delivery arm (not shown) disposed adjacent thereto configured to supply electrolyte to a planarizing surface of the processing pad assembly 604. The platen assembly 602 includes at least one of a meter or sensor 254 (shown in FIG. 3) to facilitate endpoint detection.

In one embodiment, the processing pad assembly 604 includes interposed pad 612 sandwiched between a conductive pad 610 and an electrode 614. The conductive pad 610 is substantially conductive across its top processing surface and is generally made from a conductive material or a conductive composite (i.e., the conductive elements are dispersed integrally with or comprise the material comprising the planarizing surface), such as a polymer matrix having conductive particles dispersed therein or a conductive coated fabric, among others. The conductive pad 610, the interposed pad 612, and the electrode 614 may be fabricated into a single, replaceable assembly. The processing pad assembly 604 is generally permeable or perforated to allow electrolyte to pass between the electrode 614 and top surface 620 of the conductive pad 610. In the embodiment depicted in FIG. 7, the processing pad assembly 604 is perforated by apertures 622 to allow electrolyte to flow therethrough. In one embodiment, the conductive pad 610 is comprised of a conductive material disposed on a polymer matrix disposed on a conductive fiber, for example, tin particles in a polymer matrix disposed on a woven copper coated polymer. The conductive pad 610 may also be utilized for the contact assembly 250 in the embodiment of FIG. 3.

A conductive foil 616 may additionally be disposed between the conductive pad 610 and the subpad 612. The foil 616 is coupled to a power source 242 and provides uniform distribution of voltage applied by the source 242 across the conductive pad 610. In embodiments not including the conductive foil 616, the conductive pad 610 may be coupled directly, for example, via a terminal integral to the pad 610, to the power source 242. Additionally, the pad assembly 604 may include an interposed pad 618, which, along with the foil 616, provides mechanical strength to the overlying conductive pad 610. Examples of suitable pad assemblies are described in the previously incorporated U.S. Patent Publications.

Polishing Composition and Process

In one aspect, polishing compositions that can planarize metals, such as tungsten, are provided. Generally, the polishing composition includes one or more acid based electrolyte systems, a first chelating agent including an organic salt, a pH adjusting agent to provide a pH between about 2 and about 10 and a solvent. The polishing composition may further include a second chelating agent having one or more functional groups selected from the group consisting of amine groups, amide groups, and combinations thereof. The one or more acid based electrolyte systems preferably include two acid based electrolyte systems, for example, a sulfuric acid based electrolyte system and a phosphoric acid based electrolyte system. Embodiments of the polishing composition may be used for polishing bulk and/or residual materials. The polishing composition may optionally include one or more corrosion inhibitors or a polishing enhancing material, such as abrasive particles. While the compositions described herein are oxidizer free compositions, the invention contemplates the use of oxidizers as a polishing enhancing material that may further be used with an abrasive material. It is believed that the polishing compositions described herein improve the effective removal rate of materials, such as tungsten, from the substrate surface during ECMP, with a reduction in planarization type defects and yielding a smoother substrate surface. The embodiments of the compositions may be used in a one-step or two-step polishing process.

Although the polishing compositions are particularly useful for removing tungsten. It is believed that the polishing compositions may also remove other conductive materials, such as aluminum, platinum, copper, titanium, titanium nitride, tantalum, tantalum nitride, cobalt, gold, silver, ruthenium and combinations thereof. Mechanical abrasion, such as from contact with the conductive pad 203 and/or abrasives, and/or anodic dissolution from an applied electrical bias, may be used to improve planarity and improve removal rate of these conductive materials.

The sulfuric acid based electrolyte system includes, for example, electrolytes and compounds having a sulfate group (SO₄²⁻), such as sulfuric acid (H₂SO₄), and/or derivative salts thereof including, for example, ammonium hydrogen sulfate (NH₄HSO₄), ammonium sulfate, potassium sulfate, tungsten sulfate, or combinations thereof, of which sulfuric acid is preferred. Derivative salts may include ammonium (NH₄⁺), sodium (Na⁺), tetramethyl ammonium (Me₄N⁺, potassium (K⁺) salts, or combinations thereof, among others.

The phosphoric acid based electrolyte system includes, for example, electrolytes and compounds having a phosphate group (PO₄³⁻), such as, phosphoric acid, and/or derivative salts thereof including, for example, phosphate (MₓH₍₃₋ₓ₎PO₄) (x=1, 2, 3), with M including ammonium (NH₄⁺), sodium (Na⁺), tetramethyl ammonium (Me₄N⁺) or potassium (K⁺) salts, tungsten phosphate, ammonium dihydrogen phosphate ((NH₄)H₂PO₄), diammonium hydrogen phosphate ((NH₄)₂HPO₄), and combinations thereof, of which phosphoric acid is preferred. Alternatively, an acetic acid based electrolytic, including acetic acid and/or derivative salts, or a salicylic acid based electrolyte, including salicylic acid and/or derivative salts, may be used in place of the phosphoric acid based electrolyte system. The acid based electrolyte systems described herein may also buffer the composition to maintain a desired pH level for processing a substrate. The invention also contemplates that conventional electrolytes known and unknown may also be used in forming the composition described herein using the processes described herein.

The sulfuric acid based electrolyte system and phosphoric acid based electrolyte system may respectively, include between about 0.1 and about 30 percent by weight (wt %) or volume (vol %) of the total composition of solution to provide suitable conductivity for practicing the processes described herein. Acid electrolyte concentrations between about 0.2 vol % and about 5 vol %, such as about 0.5 vol % and about 3 vol %, for example, between about 1 vol % and about 3 vol %, may be used in the composition. The respective acid electrolyte compositions may also vary between polishing compositions. For example in a first composition, the acid electrolyte may comprise between about 1.5 vol % and about 3 vol % sulfuric acid and between about 2 vol % and about 3 vol % phosphoric acid for bulk metal removal and in a second composition, between about 1 vol % and about 2 vol % sulfuric acid and between about 1.5 vol % and about 2 vol % phosphoric acid for residual metal removal. The invention contemplates embodiments of the composition including a second composition having a sulfuric acid and/or phosphoric acid concentration less than the first composition.

One aspect or component of the present invention is the use of one or more chelating agents to complex with the surface of the substrate to enhance the electrochemical dissolution process. In any of the embodiments described herein, the chelating agents can bind to ions of a conductive material, such as tungsten ions, increase the removal rate of metal materials and/or improve polishing performance. The chelating agents may also be used to buffer the polishing composition to maintain a desired pH level for processing a substrate.

One suitable category of chelating agents includes inorganic or organic acid salts. Salts of other organic acids which may be suitable are salts of compounds having one or more functional groups selected from the group of carboxylate groups, dicarboxylate groups, tricarboxylate groups, a mixture of hydroxyl and carboxylate groups, and combinations thereof. The metal materials for removal, such as tungsten, may be in any oxidation state before, during or after ligating with a functional group. The functional groups can bind the metal materials created on the substrate surface during processing and remove the metal materials from the substrate surface.

Examples of suitable inorganic or organic acid salts include ammonium and potassium salts of organic acids, such as ammonium oxalate, ammonium citrate, ammonium succinate, monobasic potassium citrate, dibasic potassium citrate, tribasic potassium citrate, potassium tartarate, ammonium tartarate, potassium succinate, potassium oxalate, and combinations thereof. Examples of suitable acids for use in forming the salts of the chelating agent that having one or more carboxylate groups include citric acid, tartaric acid, succinic acid, oxalic acid, acetic acid, adipic acid, butyric acid, capric acid, caproic acid, caprylic acid, glutaric acid, glycolic acid, formaic acid, fumaric acid, lactic acid, lauric acid, malic acid, maleic acid, malonic acid, myristic acid, plamitic acid, phthalic acid, propionic acid, pyruvic acid, stearic acid, valeric acid, and combinations thereof.

The polishing composition may include one or more inorganic or organic salts at a concentration between about 0.1% and about 15% by volume or weight of the composition, for example, between about 0.2% and about 5% by volume or weight, such as between about 1% and about 3% by volume or weight. For example, between about 0.5% and about 2% by weight of ammonium citrate may be used in the polishing composition.

Alternatively, a second chelating agent having one or more functional groups selected from the group of amine groups, amide groups, hydroxyl groups, and combinations thereof, may be used in the composition. Preferred functional groups are selected from the group consisting of amine groups, amide groups, hydroxyl groups, and combinations thereof, do not have acidic functional groups such as carboxylate groups, dicarboxylate groups, tricarboxylate groups, and combinations thereof. The polishing composition may include one or more chelating agents having one or more functional groups selected from the group of amine groups, amide groups, hydroxyl groups, and combinations thereof, at a concentration between about 0.1% and about 5% by volume or weight, but preferably utilized between about 1% and about 3% by volume or weight, for example about 2% by volume or weight. For example, between about 2 vol % and about 3 vol % of ethylenediamine may be used as a chelating agent. Further examples of suitable chelating agents include compounds having one or more amine and amide functional groups, such as ethylenediamine, and derivatives thereof including diethylenetriamine, hexadiamine, amino acids, ethylenediaminetetraacetic acid, methylformamide, or combinations thereof.

The solution may include one or more pH adjusting agents to achieve a pH between about 2 and about 10. The amount of pH adjusting agent can vary as the concentration of the other components is varied in different formulations, but in general the total solution may include up to about 70 wt % of the one or more pH adjusting agents, but preferably between about 0.2 wt % and about 25 wt. %. Different compounds may provide different pH levels for a given concentration, for example, the composition may include between about 0.1 wt % and about 10 wt % of a base, such as potassium hydroxide, sodium hydroxide, ammonium hydroxide, tetramethyl ammonium hydroxide (TMAH), or combinations thereof, to provide the desired pH level. The one or more pH adjusting agents can be chosen from a class of organic acids, for example, carboxylic acids, such as acetic acid, citric acid, oxalic acid, phosphate-containing components including phosphoric acid, ammonium phosphates, potassium phosphates, and combinations thereof, or a combination thereof. Inorganic acids including hydrochloric acid, sulfuric acid, and phosphoric acid may also be used in the polishing composition.

Typically, the amount of pH adjusting agents in the polishing composition will vary depending on the desired pH range for components having different constituents for various polishing processes. For example, in a bulk tungsten polishing process, the amount of pH adjusting agents may be adjusted to produce pH levels between about 6 and about 10. The pH in one embodiment of the bulk tungsten removal composition is a neutral or basic pH in the range between about 7 and about 9, for example, a basic solution greater than 7 and less than or equal to about 9, such as between about 8 and about 9.

In a further example for a residual tungsten polishing process, the amount of pH adjusting agents may be adjusted to produce pH levels between about 2 and about 8. The pH in one embodiment of the residual tungsten removal composition is a neutral or acidic pH in the range between about 6 and about 7, for example, an acidic pH greater than 6 and less than 7, such as between about 6.4 and about 6.8.

The compositions included herein may include between about 1 vol % and about 5 vol % of sulfuric acid, between about 1 vol % and about 5 vol % of phosphoric acid, between about 1 wt % and about 5 wt % of ammonium citrate, between about 0.5 wt % and about 5 wt % of ethylenediamine, a pH adjusting agent to provide a pH between about 6 and about 10, and deionized water, such as a composition including between about 1 vol % and about 3 vol % of sulfuric acid, between about 1 vol % and about 3 vol % of phosphoric acid, between about 1 wt % and about 3 wt % of ammonium citrate, between about 1 wt % and about 3 wt % of ethylenediamine, potassium hydroxide to provide a pH between about 7 and about 9, and deionized water. Another embodiment of the composition may include between about 0.2 vol % and about 5 vol % of sulfuric acid, between about 0.2 vol % and about 5 vol % of phosphoric acid, between about 0.1 wt % and about 5 wt % of ammonium citrate, a pH adjusting agent to provide a pH between about 2 and about 8, such as between about 3 and about 8, and deionized water. Another embodiment of the composition may include between about 0.5 vol % and about 2 vol % of sulfuric acid, between about 0.5 vol % and about 2 vol % of phosphoric acid, between about 0.5 wt % and about 2 wt % of ammonium citrate, potassium hydroxide to provide a pH between about 6 and about 7, and deionized water.

In any of the embodiments described herein, the preferred polishing compositions described herein are oxidizer-free compositions, for example, compositions free of oxidizers and oxidizing agents. Examples of oxidizers and oxidizing agents include, without limitation, hydrogen peroxide, ammonium persulfate, potassium iodate, potassium permanganate, and cerium compounds including ceric nitrate, ceric ammonium nitrate, bromates, chlorates, chromates, iodic acid, among others.

Alternatively, the polishing compositions may include an oxidizing compound. Examples of suitable oxidizer compounds beyond those listed herein are nitrate compounds including ferric nitrate, nitric acid, and potassium nitrate. In one alternative embodiment of the compositions described herein, a nitric acid based electrolyte system, such as electrolytes and compounds having a nitrate group (NO₃¹⁻), such as nitric acid (HNO₃), and/or derivative salts thereof, including ferric nitrate (Fe(NO₃)₃), may be used in place of the sulfuric acid based electrolyte.

In any of the embodiments described herein, etching inhibitors, for example, corrosion inhibitors, can be added to reduce the oxidation or corrosion of metal surfaces, by chemical or electrical means, by forming a layer of material which minimizes the chemical interaction between the substrate surface and the surrounding electrolyte. The layer of material formed by the inhibitors may suppress or minimize the electrochemical current from the substrate surface to limit electrochemical deposition and/or dissolution.

Etching inhibitors of tungsten inhibits the conversion of solid tungsten into soluble tungsten compounds while at the same time allowing the composition to convert tungsten to a soft oxidized film that can be evenly removed by abrasion. Useful etching inhibitors for tungsten include compounds having nitrogen containing functional groups such as nitrogen containing heteroycles, alkyl ammonium ions, amino alkyls, amino acids. Etching inhibitors include corrosion inhibitors, such as compounds including nitrogen containing heterocycle functional groups, for example, 2,3,5-trimethylpyrazine, 2-ethyl-3,5-dimethylpyrazine, quinoxaline, acetyl pyrrole, pyridazine, histidine, pyrazine, benzimidazole and mixtures thereof.

The term “alkyl ammonium ion” as used herein refers to nitrogen containing compounds having functional groups that can produce alkyl ammonium ions in aqueous solutions. The level of alkylammonium ions produced in aqueous solutions including compounds with nitrogen containing functional groups is a function of solution pH and the compound or compounds chosen. Examples of nitrogen containing functional group corrosion inhibitors that produce inhibitory amounts of alkyl ammonium ion functional groups at aqueous solution with a pH less than 9.0 include isostearylethylimididonium, cetyltrimethyl ammonium hydroxide, alkaterge E (2-heptadecenyl-4-ethyl-2 oxazoline 4-methanol), aliquat 336 (tricaprylmethyl ammonium chloride), nuospet 101 (4,4 dimethyloxazolidine), tetrabutylammonium hydroxide, dodecylamine, tetramethylammonium hydroxide, derivatives thereof, and mixtures thereof.

Useful amino alkyl corrosion inhibitors include, for example, aminopropylsilanol, aminopropylsiloxane, dodecylamine, mixtures thereof, and synthetic and naturally occurring amino acids including, for example, lysine, tyrosine, glutamine, glutamic acid, glycine, cystine and glycine.

A preferred alkyl ammonium ion functional group containing inhibitor of tungsten etching is SILQUEST A-1106 silane, manufactured by OSI Specialties, Inc. SILQUEST A-1106 is a mixture of approximately 60 weight percent (wt %) water, approximately 30 wt % aminopropylsiloxane, and approximately 10 wt % aminopropylsilanol. The aminopropylsiloxane and aminopropylsilanol each form an inhibiting amount of corresponding alkylammonium ions at a pH less than about 7. A most preferred amino alkyl corrosion inhibitor is glycine (aminoacetic acid).

Examples of suitable inhibitors of tungsten etching include halogen derivatives of alkyl ammonium ions, such as dodecyltrimethylammonium bromide, imines, such as polyethyleneimine, carboxy acid derivatives, such as calcium acetate, organosilicon compounds, such as di(mercaptopropyl)dimethoxylsilane, and polyacrylates, such as polymethylacrylate.

The inhibitor of tungsten etching should be present in the composition of this invention in amounts ranging from about 0.001 wt % to about 2.0 wt % and preferably from about 0.005 wt % to about 1.0 wt %, and most preferably from about 0.01 wt % to about 0.10 wt %.

The inhibitors of tungsten etching are effective at composition with a pH up to about 9.0. It is preferred that the compositions of this invention have a pH of less than about 7.0 and most preferably less than about 6.5.

Other inhibitors may include between about 0.001% and about 5.0% by weight of the organic compound from one or more azole groups. The commonly preferred range being between about 0.2% and about 0.4% by weight. Examples of organic compounds having azole groups include benzotriazole, mercaptobenzotriazole, 5-methyl-1-benzotriazole, and combinations thereof. Other suitable corrosion inhibitors include film forming agents that are cyclic compounds, for example, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. Other corrosion inhibitors include urea and thiourea among others.

Alternatively, polymeric inhibitors, for non-limiting examples, polyalkylaryl ether phosphate or ammonium nonylphenol ethoxylate sulfate, may be used in replacement or conjunction with azole containing inhibitors in an amount between about 0.002% and about 1.0% by volume or weight of the composition.

While the polishing compositions described above are free of oxidizers (oxidizer-free) and/or abrasive particles (abrasive-free), the polishing composition contemplates including one or more surface finish enhancing and/or removal rate enhancing materials including abrasive particles, one or more oxidizers, and combinations thereof. One or more surfactants may be used in the polishing composition to increase the dissolution or solubility of materials, such as metals and metal ions or by-products produced during processing, reduce any potential agglomeration of abrasive particles in the polishing composition, improve chemical stability, and reduce decomposition of components of the polishing composition. Suitable oxidizers and abrasives are described in co-pending United States Patent Publication No. 2003/0178320 A1, published Sep. 25, 2003, which is incorporated by reference herein to the extent not inconsistent with the claimed aspects and disclosure herein.

Alternatively, the polishing composition may further include electrolyte additives including suppressors, enhancers, levelers, brighteners, stabilizers, and stripping agents to improve the effectiveness of the polishing composition in polishing of the substrate surface. For example, certain additives may decrease the ionization rate of the metal atoms, thereby inhibiting the dissolution process, whereas other additives may provide a finished, shiny substrate surface. The additives may be present in the polishing composition in concentrations up to about 15% by weight or volume, and may vary based upon the desired result after polishing.

Further examples of additives to the polishing composition are more fully described in U.S. Pat. No. 6,863,797, issued on Mar. 8, 2005, which is incorporated by reference herein to the extent not inconsistent with the claimed aspects and disclosure herein.

The balance or remainder of the polishing compositions described above is a solvent, such as a polar solvent, including water, preferably deionized water. Other solvents may include, for example, organic solvents, such as alcohols or glycols, and in some embodiments may be combined with water. The amount of solvent may be used to control the concentrations of the various components in the composition. For example, the electrolyte may be concentrated up to three times as concentrated as described herein and then diluted with the solvent prior to use of diluted at the processing station as described herein.

Generally, ECMP solutions are much more conductive than traditional CMP solutions. The ECMP solutions have a conductivity of about 10 milliSiemens (mS) or higher, while traditional CMP solutions have a conductivity from about 3 mS to about 5 mS. The conductivity of the ECMP solutions greatly influences the rate at which the ECMP process advances, i.e., more conductive solutions have a faster material removal rate. For removing bulk material, the ECMP solution has a conductivity of about 10 mS or higher, preferably in a range between about 40 mS and about 80 mS, for example, between about 50 mS and about 70 mS, such as between about 60 and about 64 mS. For residual material, the ECMP solution has a conductivity of about 10 mS or higher, preferably in a range between about 30 mS and about 60 mS, for example, between about 40 mS and about 55 mS, such as about 49 mS.

It has been observed that a substrate processed with the polishing composition described herein has improved surface finish, including less surface defects, such as dishing, erosion (removal of dielectric material surrounding metal features), and scratches, as well as improved planarity. The compositions described herein may be further disclosed by the examples as follows.

Electrochemical Mechanical Processing:

An electrochemical mechanical polishing technique using a combination of chemical activity, mechanical activity and electrical activity to remove tungsten material and planarize a substrate surface may be performed as follows. Tungsten material includes tungsten, tungsten nitride, tungsten silicon nitride, and tungsten silicon nitride, among others. While the following process is described for tungsten removal, the invention contemplates the removal of other materials with the tungsten removal including aluminum, platinum, copper, titanium, titanium nitride, tantalum, tantalum nitride, cobalt, gold, silver, ruthenium and combinations thereof.

The removal of excess tungsten may be performed in one or more processing steps, for example, a single tungsten removal step or a bulk tungsten removal step and a residual tungsten removal step. Bulk material is broadly defined herein as any material deposited on the substrate in an amount more than sufficient to substantially fill features formed on the substrate surface. Residual material is broadly defined as any material remaining after one or more bulk or residual polishing process steps. Generally, the bulk removal during a first ECMP process removes at least about 50% of the conductive layer, preferably at least about 70%, more preferably at least about 80%, for example, at least about 90%. The residual removal during a second ECMP process removes most, if not all the remaining conductive material disposed on the barrier layer to leave behind the filled plugs.

The bulk removal ECMP process may be performed on a first polishing platen and the residual removal ECMP process on a second polishing platen of the same or different polishing apparatus as the first platen. In another embodiment, the residual removal ECMP process may be performed on the first platen with the bulk removal process. Any barrier material may be removed on a separate platen, such as the third platen in the apparatus described in FIG. 2. For example, the apparatus described above in accordance with the processes described herein may include three platens for removing tungsten material including, for example, a first platen to remove bulk material, a second platen for residual removal and a third platen for barrier removal, wherein the bulk and the residual processes are ECMP processes and the barrier removal is a CMP process or another ECMP process. In another embodiment, three ECMP platens may be used to remove bulk material, residual removal and barrier removal.

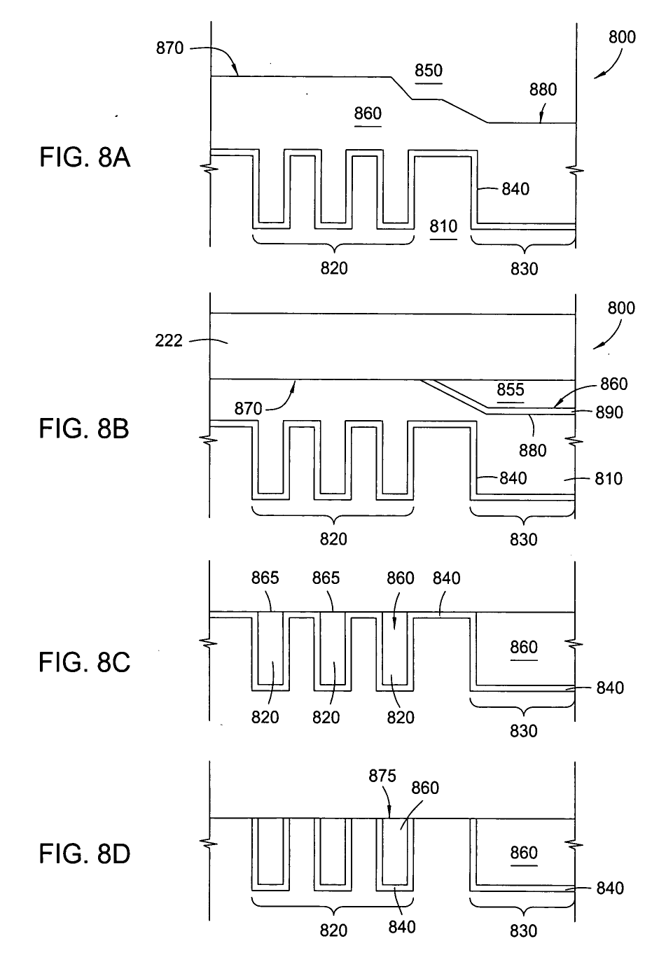

FIGS. 8A-8D are schematic cross-sectional views illustrating a polishing process performed on a substrate according to one embodiment for planarizing a substrate surface described herein. A first ECMP process may be used to remove bulk tungsten material from the substrate surface as shown from FIG. 8A and then a second ECMP process to remove residual tungsten materials as shown from FIGS. 8B-8C. Subsequent processes, such as barrier removal and buffering are used to produce the structure shown in FIG. 8D. The first ECMP process produces a fast removal rate of the tungsten layer and the second ECMP process, due to the precise removal of the remaining tungsten material, forms level substrate surfaces with reduced or minimal dishing and erosion of substrate features.

FIG. 8A is a schematic cross-sectional view illustrating one embodiment of a first electrochemical mechanical polishing technique for removal of bulk tungsten material. The substrate is disposed in a receptacle, such as a basin or platen containing a first electrode. The substrate 800 has a dielectric layer 810 patterned with narrow feature definitions 820 and wide feature definitions 830. Feature definitions 820 and feature definitions 830 have a barrier material 840, for example, titanium and/or titanium nitride, deposited therein followed by a fill of a conductive material 860, for example, tungsten. The deposition profile of the excess material includes a high overburden 870, also referred to as a hill or peak, formed over narrow feature definitions 820 and a minimal overburden 880, also referred to as a valley, over wide feature definitions 830.

A polishing composition 850 as described herein is provided to the substrate surface. The polishing composition may be provided at a flow rate between about 100 and about 400 milliliters per minute, such as about 300 milliliters per minute, to the substrate surface. An example of the polishing composition for the bulk removal step includes between about 1 vol % and about 5 vol % of sulfuric acid, between about 1 vol % and about 5 vol % of phosphoric acid, between about 1 wt % and about 5 wt % of ammonium citrate, between about 0.5 wt % and about 5 wt % of ethylenediamine, a pH adjusting agent to provide a pH between about 6 and about 10, and deionized water. A further example of a polishing composition includes about 2 vol % of sulfuric acid, about 2 vol % of phosphoric acid, about 2 wt % of ammonium citrate, about 2 wt % of ethylenediamine, potassium hydroxide to provide a pH between about 8.4 and about 8.9 and deionized water. The composition has a conductivity of between about 60 and about 64 milliSiemens (mS). The bulk polishing composition described herein having strong etchants such as sulfuric acid as well as a basic pH, in which tungsten is more soluble, allow for an increased removal rate compared to the residual polishing composition described herein.

A polishing article coupled to a polishing article assembly containing a second electrode is then physically contacted and/or electrically coupled with the substrate through a conductive polishing article. The substrate surface and polishing article are contacted at a pressure less than about 2 pounds per square inch (lb/in² or psi) (13.8 kPa). Removal of the conductive material 860 may be performed with a process having a pressure of about 1 psi (6.9 kPa) or less, for example, from about 0.01 psi (69 Pa) to about 1 psi (6.9 kPa), such as between about 0.1 (0.7 kPa) psi and about 0.8 psi (5.5 kPa) or between about 0.1 (0.7 kPa) psi and less than about 0.5 psi (3.4 kPa). In one aspect of the process, a pressure of about 0.3 psi (2.1 kPa) or less is used.

The polishing pressures used herein reduce or minimize damaging shear forces and frictional forces for substrates containing low k dielectric materials. Reduced or minimized forces can result in reduced or minimal deformations and defect formation of features from polishing. Further, the lower shear forces and frictional forces have been observed to reduce or minimize formation of topographical defects, such as erosion of dielectric materials and dishing of conductive materials as well as reducing delamination, during polishing. Contact between the substrate and a conductive polishing article also allows for electrical contact between the power source and the substrate by coupling the power source to the polishing article when contacting the substrate.

Relative motion is provided between the substrate surface and the conductive pad assembly 222. The conductive pad assembly 222 disposed on the platen is rotated at a platen rotational rate of between about 7 rpm and about 50 rpm, for example, about 28 rpm, and the substrate disposed in a carrier head is rotated at a carrier head rotational rate between about 7 rpm and about 70 rpm, for example, about 37 rpm. The respective rotational rates of the platen and carrier head are believed to provide reduced shear forces and frictional forces when contacting the polishing article and substrate. Both the carrier head rotational speed and the platen rotational speed may be between about 7 rpm and less than 40 rpm. In one aspect of the invention, the processes herein may be performed with carrier head rotational speed greater than a platen rotational speed by a ratio of carrier head rotational speed to platen rotational speed of greater than about 1:1, such as a ratio of carrier head rotational speed to platen rotational speed between about 1.5:1 and about 12:1, for example between about 1.5:1 and about 3:1, to remove the tungsten material.

A bias from a power source 224 is applied between the two electrodes. The bias may be transferred from a conductive pad and/or electrode in the polishing article assembly 222 to the substrate 208. The process may also be performed at a temperature between about 20° C. and about 60° C.

The bias is generally provided at a current density up to about 100 mA/cm² which correlates to an applied current of about 40 amps to process substrates with a diameter up to about 300 mm. For example, a 200 mm diameter substrate may have a current density from about 0.01 mA/cm² to about 50 mA/cm², which correlates to an applied current from about 0.01 A to about 20 A. The invention also contemplates that the bias may be applied and monitored by volts, amps and watts. For example, in one embodiment, the power supply may apply a power between about 0 watts and 100 watts, a voltage between about 0 V and about 10 V, and a current between about 0.01 amps and about 10 amps. In one example of power application a voltage of between about 2.5 volts and about 4.5, such as about 3 volts, is applied during application of the bulk polishing composition described herein to the substrate. The substrate is typically exposed to the polishing composition and power application for a period of time sufficient to remove the bulk of the overburden of tungsten disposed thereon.

The bias may be varied in power and application depending upon the user requirements in removing material from the substrate surface. For example, increasing power application has been observed to result in increasing anodic dissolution. The bias may also be applied by an electrical pulse modulation technique. Pulse modulation techniques may vary, but generally include a cycle of applying a constant current density or voltage for a first time period, then applying no current density or voltage or a constant reverse current density or voltage for a second time period. The process may then be repeated for one or more cycles, which may have varying power levels and durations. The power levels, the duration of power, an “on” cycle, and no power, an “off” cycle” application, and frequency of cycles, may be modified based on the removal rate, materials to be removed, and the extent of the polishing process. For example, increased power levels and increased duration of power being applied have been observed to increase anodic dissolution.

In one pulse modulation process for electrochemical mechanical polishing, the pulse modulation process comprises an on/off power technique with a period of power application, “on”, followed by a period of no power application, “off”. The on/off cycle may be repeated one or more times during the polishing process. The “on” periods allow for removal of exposed conductive material from the substrate surface and the “off” periods allow for polishing composition components and by-products of “on” periods, such as metal ions, to diffuse to the surface and complex with the conductive material. During a pulse modulation technique process it is believed that the metal ions migrate and interact with the corrosion inhibitors and/or chelating agents by attaching to the passivation layer in the non-mechanically disturbed areas. The process thus allows etching in the electrochemically active regions, not covered by the passivation layer, during an “on” application, and then allowing reformation of the passivation layer in some regions and removal of excess material during an “off” portion of the pulse modulation technique in other regions. Thus, control of the pulse modulation technique can control the removal rate and amount of material removed from the substrate surface.

The “on”/“off” period of time may be between about 1 second and about 60 seconds each, for example, between about 2 seconds and about 25 seconds, and the invention contemplates the use of pulse techniques having “on” and “off” periods of time greater and shorter than the described time periods herein. In one example of a pulse modulation technique, anodic dissolution power is applied between about 16% and about 66% of each cycle.

Non-limiting examples of pulse modulation technique with an on/off cycle for electrochemical mechanical polishing of materials described herein include: applying power, “on”, between about 5 seconds and about 10 seconds and then not applying power, “off”, between about 2 seconds and about 25 seconds; applying power for about 10 seconds and not applying power for 5 seconds, or applying power for 10 seconds and not applying power for 2 seconds, or even applying power for 5 seconds and not applying power for 25 seconds to provide the desired polishing results. The cycles may be repeated as often as desired for each selected process. One example of a pulse modulation process is described in commonly assigned U.S. Pat. No. 6,379,223, which is incorporated by reference herein to the extent not inconsistent with the claimed aspects and disclosure herein. Further examples of a pulse modulation process is described in co-pending United States Patent Publication No. 2004/0072445 A1, entitled “Effective Method To Improve Surface Finish In Electrochemically Assisted Chemical Mechanical Polishing,” published Apr. 15, 2004, which is incorporated by reference herein to the extent not inconsistent with the claimed aspects and disclosure herein.

A removal rate of conductive material of up to about 15,000 Å/min can be achieved by the processes described herein. Higher removal rates are generally desirable, but due to the goal of maximizing process uniformity and other process variables (e.g., reaction kinetics at the anode and cathode) it is common for dissolution rates to be controlled from about 100 Å/min to about 15,000 Å/min. In one embodiment of the invention where the bulk tungsten material to be removed is less than 5,000 Å thick, the voltage (or current) may be applied to provide a removal rate from about 100 Å/min to about 5,000 Å/min, such as between about 2,000 Å/min to about 5,000 Å/min. The residual material is removed at a rate lower than the bulk removal rate and by the processes described herein may be removed at a rate between about 400 Å/min to about 1,500 Å/min.

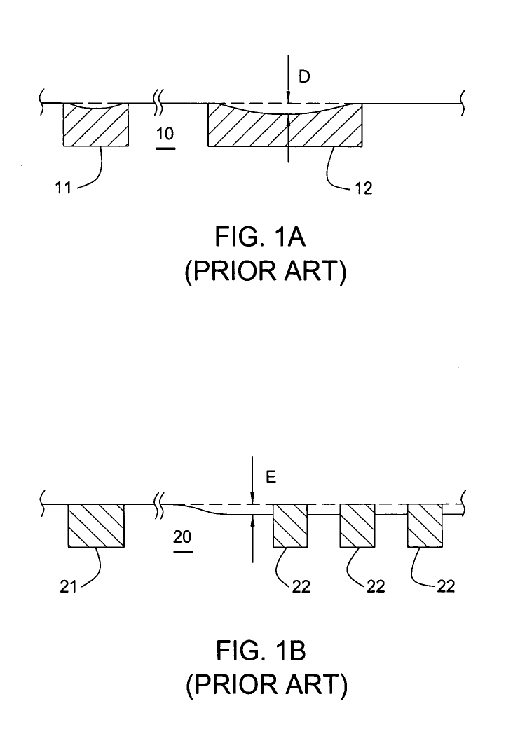

The second ECMP process is slower in order to prevent excess metal removal from forming topographical defects, such as concavities or depressions known as dishing D, as shown in FIG. 1A, and erosion E as shown in FIG. 1B. Therefore, a majority of the conductive layer 860 is removed at a faster rate during the first ECMP process than the remaining or residual conductive layer 860 during the second ECMP process. The two-step ECMP process increases throughput of the total substrate processing and while producing a smooth surface with little or no defects.

FIG. 8B illustrates the second ECMP polishing step after at least about 50% of the conductive material 860 was removed after the bulk removal of the first ECMP process, for example, about 90%. After the first ECMP process, conductive material 860 may still include the high overburden 870, peaks, and/or minimal overburden 880, valleys, but with a reduced proportionally size. However, conductive material 860 may also be rather planar across the substrate surface (not pictured).

A second polishing composition as described herein for residual material removal is provided to the substrate surface. The polishing composition may be provided at a flow rate between about 100 and about 400 milliliters per minute, such as about 300 milliliters per minute. An example of the polishing composition for the residual removal step includes between about 0.2 vol % and about 5 vol % of sulfuric acid, between about 0.2 vol % and about 5 vol % of phosphoric acid, between about 0.1 wt % and about 5 wt % of ammonium citrate, a pH adjusting agent to provide a pH between about 3 and about 8, and deionized water, such as a polishing composition including about 1 vol % of sulfuric acid, about 1.5 vol % of phosphoric acid, about 0.5 wt % of ammonium citrate, potassium hydroxide to provide a pH between about 6.4 and about 6.8, and deionized water. The residual removal composition has a conductivity of about 49 milliSiemens (mS).

The residual polishing composition described herein is believed to form a polytungsten layer 890 on the surface of the exposed tungsten material. The polytungsten layer is formed by the chemical interaction between the ammonium citrate and phosphoric acid and the exposed tungsten material. The polytungsten layer is a more stable material than the tungsten material and is removed at a lower rate than the tungsten material. The polytungsten layer may also chemically and/or electrically insulate material disposed on a substrate surface. It is further believed that increasing the acidic pH of the polishing composition enhances the formation of polytungsten material on the substrate surface. A more acidic residual polishing composition is used as compared to the more basic bulk removal composition. A polytungsten layer may also be formed under the process conditions and the polishing compositions described for the bulk polishing process.

The thickness and density of the polytungsten layer can dictate the extent of chemical reactions and/or amount of anodic dissolution. For example, a thicker or denser polytungsten layer has been observed to result in less anodic dissolution compared to thinner and less dense passivation layers. Thus, control of the composition of pH of the composition, phosphoric acid, and/or chelating agents, allow control of the removal rate and amount of material removed from the substrate surface. The resulting reduced removal rate as compared to the bulk polishing composition reduces or minimizes formation of topographical defects, such as erosion of dielectric materials and dishing of conductive materials as well as reducing delamination, during polishing.

The mechanical abrasion in the above residual removal process are performed at a contact pressure less than about 2 pounds per square inch (lb/in² or psi) (13.8 kPa) between the polishing pad and the substrate. Removal of the conductive material 860 may be performed with a process having a pressure of about 1 psi (6.9 kPa) or less, for example, from about 0.01 psi (69 Pa) to about 1 psi (6.9 kPa), such as between about 0.1 (0.7 kPa) psi and about 0.8 psi (5.5 kPa). In one aspect of the process, a pressure of about 0.3 psi (2.1 kPa) or less is used. Contact between the substrate and a conductive polishing article also allows for electrical contact between the power source and the substrate by coupling the power source to the polishing article when contacting the substrate.

Relative motion is provided between the substrate surface and the conductive pad assembly 222. The conductive pad assembly 222 disposed on the platen is rotated at a rotational rate of between about 7 rpm and about 50 rpm, for example, about 28 rpm, and the substrate disposed in a carrier head is rotated at a rotational rate between about 7 rpm and about 70 rpm, for example, about 37 rpm. The respective rotational rates of the platen and carrier head are believed to provide reduce shear forces and frictional forces when contacting the polishing article and substrate.

Mechanical abrasion by a conductive polishing article removes the polytungsten layer 890 that insulates or suppresses the current for anodic dissolution, such that areas of high overburden are preferentially removed over areas of minimal overburden as the polytungsten layer 890 is retained in areas of minimal or no contact with the conductive pad assembly 222. The removal rate of the conductive material 860 covered by the polytungsten layer 890 is less than the removal rate of conductive material without the polytungsten layer 890. As such, the excess material disposed over narrow feature definitions 820 and the substrate field 855 is removed at a higher rate than over wide feature definitions 830 still covered by the polytungsten layer 890.

A bias from a power source 224 is applied between the two electrodes. The bias may be transferred from a conductive pad and/or electrode in the polishing article assembly 222 to the substrate 208. The bias is as applied above for the bulk polishing process, and typically uses a power level less than or equal to the power level of the bulk polishing process. For example, for the residual removal process, the power application is of a voltage of between about 1.8 volts and about 2.5, such as 2 volts. The substrate is typically exposed to the polishing composition and power application for a period of time sufficient to remove at least a portion or all of the desired material disposed thereon. The process may also be performed at a temperature between about 20° C. and about 60° C.

Referring to FIG. 8C, most, if not all of the conductive layer 860 is removed to expose barrier layer 840 and conductive trenches 865 by polishing the substrate with a second, residual, ECMP process including the second ECMP polishing composition described herein. The conductive trenches 865 are formed by the remaining conductive material 860. Any residual conductive material and barrier material may then be polished by a third polishing step to provide a planarized substrate surface containing conductive trenches 875, as depicted in FIG. 8D. The third polishing process may be a third ECMP process or a CMP process. An example of a barrier polishing process is disclosed in United States Patent Publication No. 2003/0013306 A1, entitled, “Dual Reduced Agents for Barrier Removal in Chemical Mechanical Polishing,” published Jan. 16, 2003, which is incorporated herein to the extent not inconsistent with the claims aspects and disclosure herein. A further example of a barrier polishing process is disclosed in United States Patent Publication No. 2005/0233578 A1 published Oct. 20, 2005, claiming the benefit of U.S. Provisional Patent Application Ser. No. 60/572,183 filed May 17, 2004, which is incorporated herein to the extent not inconsistent with the claims aspects and disclosure herein.

After conductive material and barrier material removal processing steps, the substrate may then be buffed to minimize surface defects. Buffing may be performed with a soft polishing article, i.e., a hardness of about 40 or less on the Shore D hardness scale as described and measured by the American Society for Testing and Materials (ASTM), headquartered in Philadelphia, Pa., at reduced polishing pressures, such as about 2 psi or less.

Optionally, a cleaning solution may be applied to the substrate after each of the polishing processes to remove particulate matter and spent reagents from the polishing process as well as help minimize metal residue deposition on the polishing articles and defects formed on a substrate surface. An example of a suitable cleaning solution is ELECTRA CLEAN™, commercially available from Applied Materials, Inc., of Santa Clara, Calif.

Finally, the substrate may be exposed to a post polishing cleaning process to reduce defects formed during polishing or substrate handling. Such processes can minimize undesired oxidation or other defects in copper features formed on a substrate surface. An example of such a post polishing cleaning is the application of ELECTRA CLEAN™, commercially available from Applied Materials, Inc., of Santa Clara, Calif.

It has been observed that substrates planarized by the processes described herein have exhibited reduced topographical defects, such as dishing and erosion, reduced residues, improved planarity, and improved substrate finish.

The following non-limiting examples are provided to further illustrate embodiments of the invention. However, the examples are not intended to be all-inclusive and are not intended to limit the scope of the inventions described herein.

### Examples of Polishing Compositions

Examples of polishing compositions for polishing bulk tungsten material and residual tungsten materials are provided as follows. Bulk tungsten polishing compositions may include:

Example #1:

about 2 vol % of sulfuric acid;
about 2 wt % of ammonium citrate;
about 2 wt % of ethylenediamine;
potassium hydroxide to provide a pH between about 8.4 and about 8.9; and
deionized water.
   Example #2:
about 4 vol % of sulfuric acid;
about 2 wt % of ammonium citrate;
about 2 wt % of ethylenediamine;
potassium hydroxide to provide a pH between about 8 and about 9; and
deionized water.
   Example #3:
about 1.5 vol % of sulfuric acid;
about 2.5 vol % of phosphoric acid;
about 2 wt % of ammonium citrate;
about 2 wt % of ethylenediamine;
potassium hydroxide to provide a pH between about 8 and about 9; and
deionized water.
   Example #4:
about 1 vol % of sulfuric acid;
about 2 vol % of phosphoric acid;
about 2 wt % of ammonium citrate;
potassium hydroxide to provide a pH between about 8 and about 9; and
deionized water.
   Example #:
about 2 vol % of sulfuric acid;
about 2 vol % of phosphoric acid;
about 2 wt % of ammonium citrate;
about 2 wt % of ethylenediamine;
potassium hydroxide to provide a pH between about 8.4 and about 8.9; and
deionized water.
   Example #6:
about 2 vol % of sulfuric acid;
about 2 vol % of salicylic acid;
potassium hydroxide to provide a pH between about 8 and about 9; and
deionized water.
   Example #7:
about 2 vol % of sulfuric acid;
about 2 vol % of phosphoric acid;
about 2 wt % of ammonium citrate;
potassium hydroxide to provide a pH of about 8.7; and
deionized water.
   Example #8:
about 2 vol % of sulfuric acid;
about 2 vol % of phosphoric acid;
about 2 wt % of ammonium citrate;
about 2 wt % of ethylenediamine;
potassium hydroxide to provide a pH of about 8.7; and
deionized water.
   Example #9:
about 2 vol % of sulfuric acid;
about 2 wt % of ammonium citrate;
about 2 wt % of ethylenediamine;
potassium hydroxide to provide a pH between about 8 and about 9; and
deionized water.
   Example #10:
about 2 vol % of sulfuric acid;
about 2 vol % of phosphoric acid;
potassium hydroxide to provide a pH between about 8 and about 9; and
deionized water.
   Example #11:
about 4 vol % of phosphoric acid;
about 2 wt. % of ammonium citrate;
about 2 wt. % of ethylenediamine;
potassium hydroxide to provide a pH between about 8 and about 9; and
deionized water.
   Example #12:
about 2 vol % of phosphoric acid;
about 2 wt % of ammonium citrate;
about 2 wt % of ethylenediamine;
potassium hydroxide to provide a pH between about 8.4 and about 8.9; and
deionized water.
   Example #13:
about 2 vol % of nitric acid;
about 2 vol % of phosphoric acid;
about 2 wt % of ammonium citrate;
about 2 wt % of ethylenediamine;
potassium hydroxide to provide a pH between about 8.4 and about 8.9; and
deionized water.
   Example #14:
about 2 vol % of nitric acid;
about 2 vol % of phosphoric acid;
about 2 wt % of ammonium citrate;
about 2 wt % of ethylenediamine;
potassium hydroxide to provide a pH of about 8.5; and
deionized water.
   Example #15:
about 4 vol % of nitric acid;
about 2 wt % of ammonium citrate;
about 2 wt % of ethylenediamine;
potassium hydroxide to provide a pH between about 8 and about 9; and
deionized water.
   Example #16:
about 1.5 vol % of sulfuric acid;
about 2.5 vol % of phosphoric acid;
about 2 wt % of ammonium citrate;
about 2 wt % of ethylenediamine;
potassium hydroxide to provide a pH of about 8.5; and
deionized water.

Residual tungsten polishing compositions may include:

Example #1:

about 1 vol % of sulfuric acid;
about 1 wt. % of ammonium citrate;
potassium hydroxide to provide a pH between about 6 and about 7; and
deionized water.
   Example #2:
about 1 vol % of sulfuric acid;
about 1.5 vol % of phosphoric acid;
about 0.5 wt. % of ammonium citrate;
potassium hydroxide to provide a pH between greater than 6 and less than 7; and
deionized water.
   Example #3:
about 4 vol % of phosphoric acid;
about 0.5 wt. % of ammonium citrate;
potassium hydroxide to provide a pH between about 6 and about 7; and
deionized water.
   Example #4:
about 1 vol % of sulfuric acid;
about 1.5 vol % of phosphoric acid;
about 1 wt. % of salicylic acid;
potassium hydroxide to provide a pH between about 6 and about 7; and
deionized water.
   Example #5:
about 2 vol % of sulfuric acid;
about 2 vol % of phosphoric acid;
about 0.5 wt. % of ammonium citrate;
potassium hydroxide to provide a pH between greater than 6 and less than 7; and
deionized water.
   Example #6:
about 2 vol % of sulfuric acid;
about 2 vol % of phosphoric acid;
potassium hydroxide to provide a pH between about 6 and about 7; and
deionized water.
   Example #7:
about 1 vol % of sulfuric acid;
about 1.5 vol % of phosphoric acid;
about 0.5 wt % of ammonium citrate;
potassium hydroxide to provide a pH between about 6.4 and about 6.8; and
deionized water.
   Example #8:
about 1 vol % of nitric acid;
about 1.5 vol % of phosphoric acid;
about 0.5 wt % of ammonium citrate;
potassium hydroxide to provide a pH between about 6.4 and about 6.8; and
deionized water.
   Example #9:
about 2 vol % of nitric acid;
about 2 vol % of phosphoric acid;
about 0.5 wt. % of ammonium citrate;
potassium hydroxide to provide a pH between about 6 and less than 7; and
deionized water.
   Example #10:
about 1 vol % of sulfuric acid;
about 1.5 vol % of phosphoric acid;
about 0.5 wt % of ammonium citrate;
potassium hydroxide to provide a pH of about 6.5; and
deionized water.

### EXAMPLES OF POLISHING PROCESSES

### Example 1

A tungsten plated substrate with 300 mm diameter was polished and planarized using the following polishing composition within a modified cell on a REFLEXION® system, available from Applied Materials, Inc., of Santa Clara, Calif. A substrate having a tungsten layer of about 4,000 Å thick on the substrate surface was placed onto a carrier head in an apparatus having a first platen with a first polishing article disposed thereon. A first polishing composition was supplied to the platen at a rate of about 250 mL/min, and the first polishing composition comprising:
between about 2 vol % and about 3 vol % of sulfuric acid;
between about 2 vol % and about 4 vol % of phosphoric acid;
between about 2 wt. % and about 2.8 wt. % of ammonium citrate;
about 2 wt % of ethylenediamine;
potassium hydroxide to provide a pH between about 8 and about 9; and
deionized water.

The substrate was contacted with the first polishing article at a first contact pressure of about 0.3 psi, a first platen rotational rate of about 20 rpm, a first carrier head rotational rate of about 39 rpm and a first bias of about 2.9 volts was applied during the process. The substrate was polished and examined. The tungsten layer thickness was reduced to about 1,000 Å.

The substrate was transferred over to a second platen having a second polishing article disposed thereon. A second polishing composition was supplied to the platen at a rate of about 300 mL/min, and the second polishing composition comprising:
between about 1 vol % and about 2 vol % of sulfuric acid;
between about 1.5 vol % and about 2.5 vol % of phosphoric acid;
about 0.5 wt % of ammonium citrate;
potassium hydroxide to provide a pH between greater than 6 and less than 7; and
deionized water.

The substrate was contacted with the second polishing article at a second contact pressure of about 0.3 psi, a second platen rotational rate of about 14 rpm, a second carrier head rotational rate of about 29 rpm and a second bias of about 2.4 volts was applied during the process. The substrate was polished and examined. The excess tungsten layer formerly on the substrate surface was removed to leave behind the barrier layer and the tungsten trench.

### Example 2

A tungsten plated substrate with 300 mm diameter was polished and planarized using the following polishing composition within a modified cell on a REFLEXION® system, available from Applied Materials, Inc., of Santa Clara, Calif. A substrate having a tungsten layer of about 4,000 Å thick on the substrate surface was placed onto a carrier head in an apparatus having a first platen with a first polishing article disposed thereon. A first polishing composition was supplied to the platen at a rate of about 250 mL/min, and the first polishing composition comprising:
about 3 vol % of sulfuric acid;
about 4 vol % of phosphoric acid;
about 2.8 wt % of ammonium citrate;
about 2 wt % of ethylenediamine;
potassium hydroxide to provide a pH between about 8 and about 9; and
deionized water.

The substrate was contacted with the first polishing article at a first contact pressure of about 0.3 psi, a first platen rotational rate of about 20 rpm, a first carrier head rotational rate of about 39 rpm and a first bias of about 2.9 volts was applied during the process. The substrate was polished and examined. The tungsten layer thickness was reduced to about 1,000 Å.

The substrate was transferred over to a second platen having a second polishing article disposed thereon. A second polishing composition was supplied to the platen at a rate of about 300 mL/min, and the second polishing composition comprising:
about 2 vol % of sulfuric acid;
about 2.5 vol % of phosphoric acid;
about 0.5 wt % of ammonium citrate;
potassium hydroxide to provide a pH between greater than 6 and less than 7; and
deionized water.

The substrate was contacted with the second polishing article at a second contact pressure of about 0.3 psi, a second platen rotational rate of about 14 rpm, a second carrier head rotational rate of about 29 rpm and a second bias of about 2.4 volts was applied during the process. The substrate was polished and examined. The excess tungsten layer formerly on the substrate surface was removed to leave behind the barrier layer and the tungsten trench.

### Example 3

A tungsten plated substrate with 300 mm diameter was polished and planarized using the following polishing composition within a modified cell on a REFLEXION® system, available from Applied Materials, Inc., of Santa Clara, Calif. A substrate having a tungsten layer of about 4,000 Å thick on the substrate surface was placed onto a carrier head in an apparatus having a first platen with a first polishing article disposed thereon. A first polishing composition was supplied to the platen at a rate of about 250 mL/min, and the first polishing composition comprising:
about 2.5 vol % of sulfuric acid;
about 3 vol % of phosphoric acid;
about 2.4 wt % of ammonium citrate;
about 2 wt % of ethylenediamine;
potassium hydroxide to provide a pH between about 8 and about 9; and
deionized water.

The substrate was contacted with the first polishing article at a first contact pressure of about 0.3 psi, a first platen rotational rate of about 20 rpm, a first carrier head rotational rate of about 39 rpm and a first bias of about 2.9 volts was applied during the process. The substrate was polished and examined. The tungsten layer thickness was reduced to about 1,000 Å.

The substrate was transferred over to a second platen having a second polishing article disposed thereon. A second polishing composition was supplied to the platen at a rate of about 300 mL/min, and the second polishing composition comprising:
about 1.5 vol % of sulfuric acid;
about 2 vol % of phosphoric acid;
about 0.5 wt % of ammonium citrate;
potassium hydroxide to provide a pH between about 6.4 and about 6.8; and
deionized water.

The substrate was contacted with the second polishing article at a second contact pressure of about 0.3 psi, a second platen rotational rate of about 14 rpm, a second carrier head rotational rate of about 29 rpm and a second bias of about 2.4 volts was applied during the process. The substrate was polished and examined. The excess tungsten layer formerly on the substrate surface was removed to leave behind the barrier layer and the tungsten trench.

### Example 4

A tungsten plated substrate with 300 mm diameter was polished and planarized using the following polishing composition within a modified cell on a REFLEXION® system, available from Applied Materials, Inc., of Santa Clara, Calif. A substrate having a tungsten layer of about 4,000 Å thick on the substrate surface was placed onto a carrier head in an apparatus having a first platen with a first polishing article disposed thereon. A first polishing composition was supplied to the platen at a rate of about 250 mL/min, and the first polishing composition comprising:
about 3 vol % of sulfuric acid;
about 3 vol % of phosphoric acid;
about 2 wt % of ammonium citrate;
about 2 wt % of ethylenediamine;
potassium hydroxide to provide a pH between about 8 and about 9; and
deionized water.

The substrate was contacted with the first polishing article at a first contact pressure of about 0.3 psi, a first platen rotational rate of about 20 rpm, a first carrier head rotational rate of about 39 rpm and a first bias of about 2.9 volts was applied during the process. The substrate was polished and examined. The tungsten layer thickness was reduced to about 1,000 Å.

The substrate was transferred over to a second platen having a second polishing article disposed thereon. A second polishing composition was supplied to the platen at a rate of about 300 mL/min, and the second polishing composition comprising:
about 2 vol % of sulfuric acid;
about 2 vol % of phosphoric acid;
about 0.5 wt % of ammonium citrate;
potassium hydroxide to provide a pH between about 6.4 and about 6.8; and
deionized water.

The substrate was contacted with the second polishing article at a second contact pressure of about 0.3 psi, a second platen rotational rate of about 14 rpm, a second carrier head rotational rate of about 29 rpm and a second bias of about 2.4 volts was applied during the process. The substrate was polished and examined. The excess tungsten layer formerly on the substrate surface was removed to leave behind the barrier layer and the tungsten trench.

### Example 5

A tungsten plated substrate with 300 mm diameter was polished and planarized using the following polishing composition within a modified cell on a REFLEXION® system, available from Applied Materials, Inc., of Santa Clara, Calif. A substrate having a tungsten layer of about 4,000 Å thick on the substrate surface was placed onto a carrier head in an apparatus having a first platen with a first polishing article disposed thereon. A first polishing composition was supplied to the platen at a rate of about 250 mL/min, and the first polishing composition comprising:
about 2 vol % of sulfuric acid;
about 2 vol % of phosphoric acid;
about 2 wt % of ammonium citrate;
about 2 wt % of ethylenediamine;
potassium hydroxide to provide a pH between about 8.4 and about 8.9; and
deionized water.

The substrate was contacted with the first polishing article at a first contact pressure of about 0.3 psi, a first platen rotational rate of about 20 rpm, a first carrier head rotational rate of about 39 rpm and a first bias of about 2.9 volts was applied during the process. The substrate was polished and examined. The tungsten layer thickness was reduced to about 1,000 Å.

The substrate was transferred over to a second platen having a second polishing article disposed thereon. A second polishing composition was supplied to the platen at a rate of about 300 mL/min, and the second polishing composition comprising:
about 1 vol % of sulfuric acid;
about 1.5 vol % of phosphoric acid;
about 0.5 wt % of ammonium citrate;
potassium hydroxide to provide a pH between about 6.4 and about 6.8; and
deionized water.

The substrate was contacted with the second polishing article at a second contact pressure of about 0.3 psi, a second platen rotational rate of about 14 rpm, a second carrier head rotational rate of about 29 rpm and a second bias of about 2.4 volts was applied during the process. The substrate was polished and examined. The excess tungsten layer formerly on the substrate surface was removed to leave behind the barrier layer and the tungsten trench.

Embodiments for a system and method for removal of conductive and barrier materials from a substrate are provided. Although the embodiments disclosed below focus primarily on removing material from, e.g., planarizing, a substrate, it is contemplated that the teachings disclosed herein may be used to electroplate a substrate by reversing the polarity of an electrical bias applied between the substrate and an electrode of the system.

Method for Electroprocessing Metal and Barrier Layers

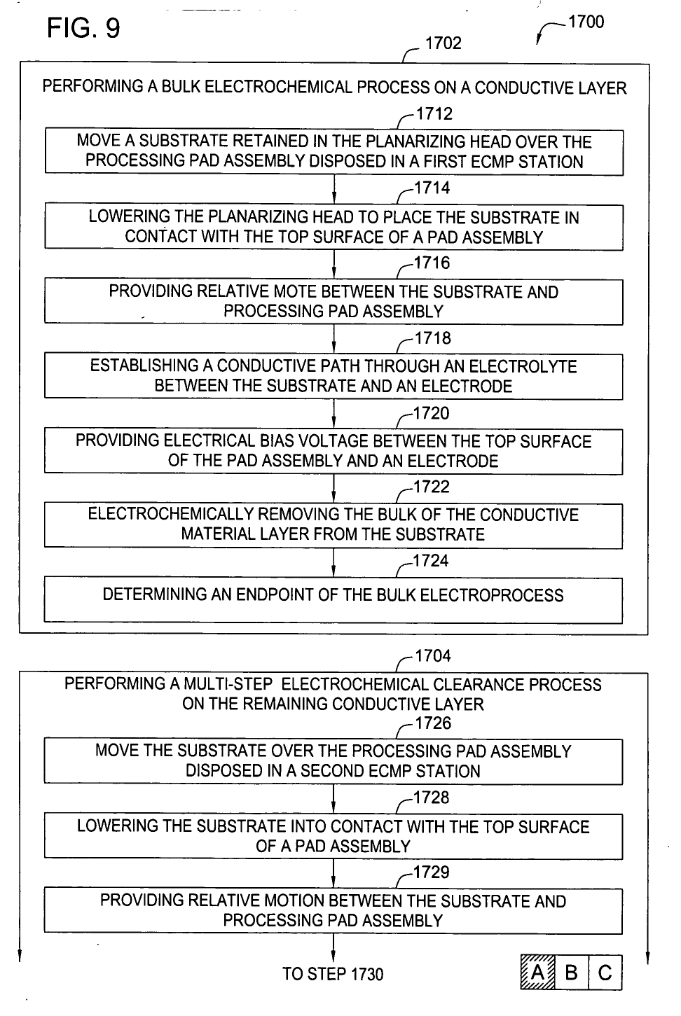

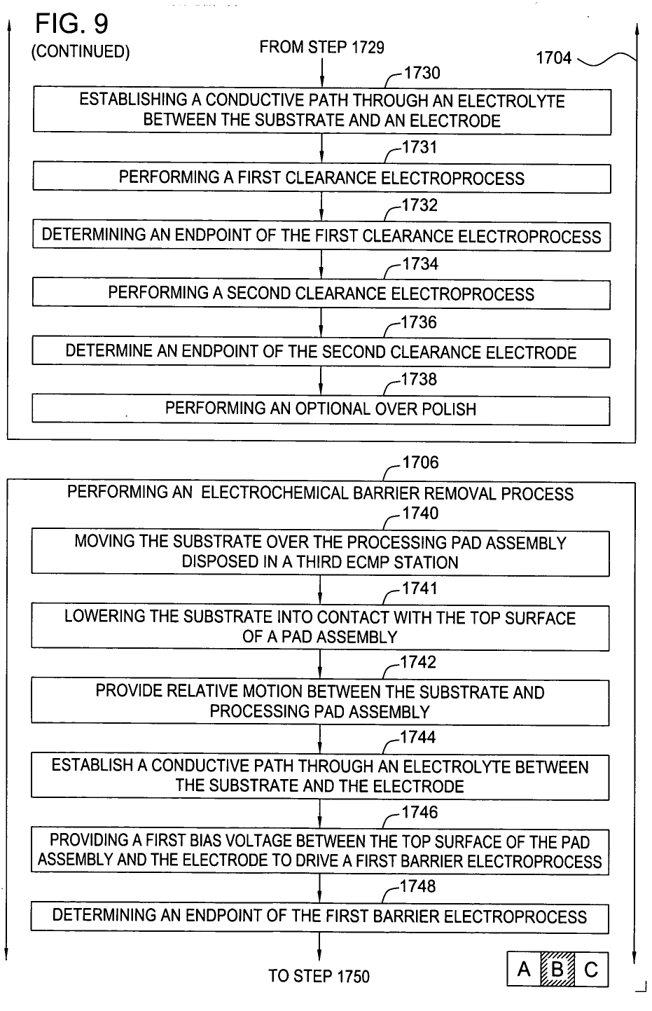

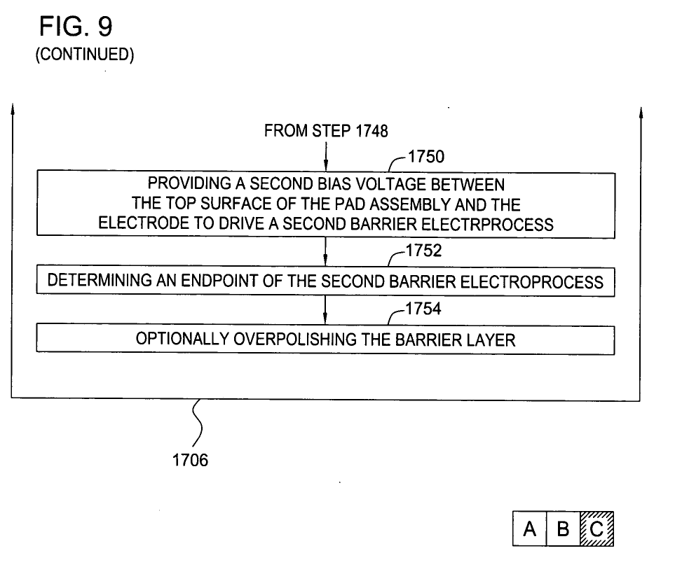

FIG. 9 depicts one embodiment of a method 1700 for electroprocessing a substrate having an exposed conductive layer and an underlying barrier layer that may be practiced on the system 100 described above. The conductive layer may be tungsten, copper, a layer having both exposed tungsten and copper, and the like. The barrier layer may be ruthenium, tantalum, tantalum nitride, titanium, titanium nitride and the like. A dielectric layer, typically an oxide, generally underlies the barrier layer. The method 1700 may also be practiced on other electroprocessing systems. The method 1700 is generally stored in the memory 112 of the controller 108, typically as a software routine. The software routine may also be stored and/or executed by a second CPU (not shown) that is remotely located from the hardware being controlled by the CPU 110.

Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware.

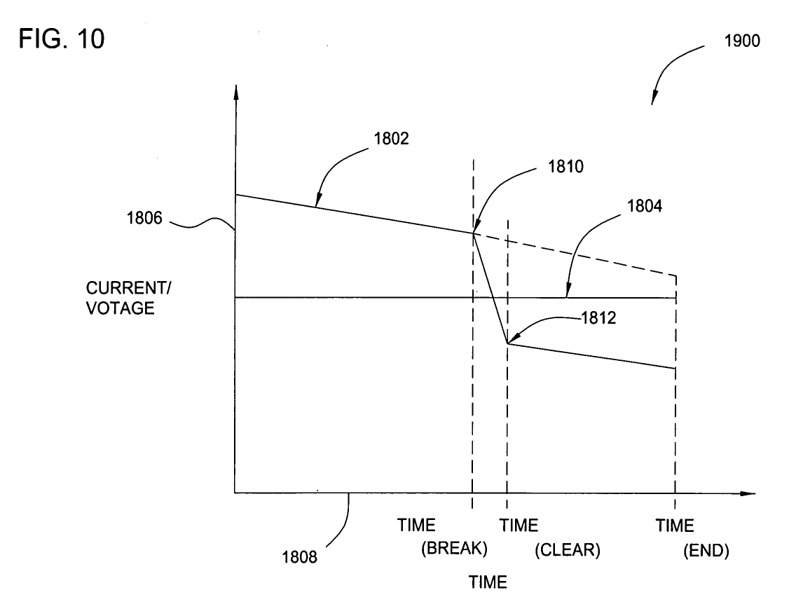

FIG. 10 depicts a graph 1800 illustrating current 1802 and voltage 1804 traces over one embodiment of an exemplary removal or planarizing method as discussed below. Amplitude is plotted on the Y-axis 1806 and time plotted on the X-axis 1808.

The method 1700 begins at step 1702 by performing a bulk electrochemical process on the conductive layer formed on the substrate 122. In one embodiment, the conductive layer is a layer of tungsten about 6000-8000′ thick. The bulk process step 1702 is at the first ECMP station 128. The bulk process step 1702 generally is terminated when the conductive layer is about 2000 to about 500 thick, or in another embodiment, less than about 1000′ thick.

Next, a multi-step electrochemical clearance step 1704 is performed to remove the remaining tungsten material to expose an underlying barrier layer, which, in one embodiment, is titanium or titanium nitride. The clearance step 1704 may be performed on the first ECMP station 128, or one of the other ECMP stations 130, 132.

Following the clearance step 1704, an electrochemical barrier removal step 1706 is performed. Typically, the electrochemical barrier removal step 1706 is performed on the third ECMP station 132, but may alternatively be performed one of the other ECMP stations 128, 130.

In one embodiment, the bulk processing step 1702 begins at step 1712 by moving the substrate 122 retained in the planarizing head 204 over the processing pad assembly 1222 disposed in the first ECMP station 128. Although the pad assembly of FIGS. 3, 4A, 5A-C and 6, is utilized in one embodiment it is contemplated that pad and contact assemblies as described in FIGS. 4B-C may alternatively be utilized. At step 1714, the planarizing head 204 is lowered toward the platen assembly 222 to place the substrate 122 in contact with the top surface of the pad assembly 222. The substrate 122 is urged against the pad assembly 222 with a force of less than about 2 pounds per square inch (psi). In one embodiment, the force is about 0.3 psi.

At step 1716, relative motion between the substrate 122 and processing pad assembly 222 is provided. In one embodiment, the planarizing head 204 is rotated at about 7-60 revolutions per minute, while the pad assembly 222 is rotated at about 7-35 revolutions per minute.

At step 1718, electrolyte is supplied to the processing pad assembly 604 to establish a conductive path therethrough between the substrate 122 and the electrode 614. The electrolyte typically includes at least one of sulfuric acid, phosphoric acid and ammonium citrate.

At step 1720, the power source 242 provides a bias voltage between the top surface of the pad assembly 222 and the electrode 292. In one embodiment, the voltage is held at a constant magnitude less than about 13.5 volts. In another embodiment where copper is the material being processed, the voltage is held at a constant magnitude less than about 3.0 volts. One or more of the contact elements 250 of the pad assembly 222 are in contact with the substrate 122 and allows the voltage to be coupled thereto. Electrolyte filling the apertures 210 between the electrode 292 and the substrate 122 provides a conductive path between the power source 242 and substrate 122 to drive an electrochemical mechanical planarizing process that results in the removal of the tungsten material, or other conductive film disposed on the substrate, by an anodic dissolution method at step 1722. The process of step 1722 generally has a tungsten removal rate of about 4000′/min. The process of step 1722 using the above stated parameters for copper processing generally has a copper removal rate of about 6000′/min.

At step 1724, an endpoint of the bulk electroprocess is determined. The endpoint may be determined using a first metric of processing provided by the meter 240. The meter 240 may provide charge, voltage or current information utilized to determine the remaining thickness of the conductive material (e.g., the tungsten or copper layer) on the substrate. In another embodiment, optical techniques, such as an interferometer utilizing the sensor 254, may be utilized. The remaining thickness may be directly measured or calculated by subtracting the amount of material removed from a predetermined starting film thickness. In one embodiment, the endpoint is determined by comparing the charge removed from the substrate to a target charge amount for a predetermined area of the substrate. Examples of endpoint techniques that may be utilized are described in U.S. Patent Publication No. 2005/0061674 A1, published Mar. 24, 2005, U.S. Pat. No. 6,837,983, issued Jan. 4, 2005, and U.S. patent application Ser. No. 10/456,851, filed Jun. 6, 2002, all of which are hereby incorporated by reference in their entireties.

The step 1724 is configured to detect the endpoint of the process prior to the breakthrough of the tungsten layer. In one embodiment, the remaining tungsten layer at step 1724 has a thickness between about 500 to about 2000′.

The clearance processing step 1704 begins at step 1726 by moving the substrate 122 retained in the planarizing head 204 over the processing pad assembly 604 disposed in the second ECMP station 130. At step 1728, the planarizing head 204 is lowered toward the platen assembly 602 to place the substrate 122 in contact with the top surface of the pad assembly 604. Although the pad assembly of FIG. 7 is utilized in one embodiment it is contemplated that pad and contact assemblies as described in FIGS. 3, 4A-C, 5A-C and 6 may alternatively be utilized. The substrate 122 is urged against the pad assembly 604 with a force in less than about 2 psi. In another embodiment, the force is less than or equal to about 0.3 psi.

At step 1729, relative motion between the substrate 122 and processing pad assembly 222 is provided. In one embodiment, the planarizing head 204 is rotated at about 10-60 revolutions per minute, while the pad assembly 222 is rotated at about 17-35 revolutions per minute.

At step 1730, electrolyte is supplied to the processing pad assembly 604 to establish a conductive path therethrough between the substrate 122 and the electrode 614. The electrolyte composition at step 1730 is generally the same as the composition at step 1722.

At a first clearance process step 1731, a first bias voltage is provided by the power source 242 between the top surface of the pad assembly 604 and the electrode 614. The bias voltage, in one embodiment, is held at a constant magnitude in the range of about 1.5 to about 2.8 volts for tungsten processing, and in another embodiment is less 2.8 volts for copper processing. The potential difference causes a current to pass through the electrolyte filling the apertures 622 between the electrode 614 and the substrate 122 to drive an electrochemical mechanical planarizing process. The process of step 1731 generally has a removal rate is about 1500′/min for tungsten and about 2000′/min for copper.

At step 1732, an endpoint of the electroprocess step 1731 is determined. The endpoint may be determined using a first metric of processing provided by the meter 240 or by the sensor 254. In one embodiment, the endpoint is determined by detecting a first discontinuity 1810 in current sensed by the meter 240. The discontinuity 1810 appears when the underlying layer begins to break through the conductive layer (e.g., the tungsten layer). As the underlying layer has a different resistivity than the tungsten layer, the resistance across the processing cell (i.e., from the conductive portion of the substrate to the electrode 292) changes as the area of tungsten layer relative to the exposed area of the underlying layer changes, thereby causing a change in the current.

In response to the endpoint detection at step 1732, a second clearance process step 1734 is preformed to remove the residual tungsten layer. The substrate is pressed against the pad assembly with a pressure less than about 2 psi, and in another embodiment, substrate is pressed against the pad assembly with a pressure less than or equal to about 0.3 psi. At step 1734, a second voltage is provided from the power source 242. The second voltage may be the same or less than the voltage applied in step 1730. In one embodiment, the second voltage is about 1.5 to about 2.8 volts. The voltage is held at a constant magnitude and passes through the electrolyte filling the apertures 622 between the electrode 614 and the substrate 122 to drive an electrochemical mechanical planarizing process. The process of step 1734 generally has a removal rate of about 500 to about 1200 Å/min for both copper and tungsten processes.

At step 1736, an endpoint of the second clearance step 1734 is determined. The endpoint may be determined using a second metric of processing provided by the meter 240 or by the sensor 254. In one embodiment, the endpoint is determined by detecting a second discontinuity 1812 in current sensed by the meter 240. The discontinuity 1812 appears when the ratio of area between the underlying layer is fully exposed through the tungsten layer that remains in the features formed in the substrate 122 (e.g., plugs or other structure).

Optionally, a third clearance process step 1738 may be performed to remove any remaining debris from the conductive layer. The third clearance process step 1738 is typically a timed process, and is performed at the same or reduced voltage levels relative to the second clearance process step 1734. In one embodiment, the third clearance process step 1738 (also referred to as an overpolish step) has a duration of about 15 to about 30 seconds.

The electrochemical barrier removal step 1706 begins at step 1740 by moving the substrate 122 retained in the planarizing head 204 over the processing pad assembly 604 disposed in the third ECMP station 132. At step 1741, the planarizing head 204 is lowered toward the platen assembly 602 to place the substrate 122 in contact with the top surface of the pad assembly 604. Although the pad assembly of FIG. 7 is utilized in one embodiment it is contemplated that pad and contact assemblies as described in FIGS. 3, 4A-C, 5A-C and 6 may alternatively be utilized. The barrier material exposed on the substrate 122 is urged against the pad assembly 604 with a force in less than about 2 psi, and in one embodiment, less than about 0.8 psi.

At step 1742, relative motion between the substrate 122 and processing pad assembly 222 is provided. In one embodiment, the planarizing head 204 is rotated at about 10-60 revolutions per minute, while the pad assembly 222 is rotated at about 17-35 revolutions per minute.

At step 1744, electrolyte is supplied to the processing pad assembly 604 to establish a conductive path therethrough between the substrate 122 and the electrode 614. The electrolyte composition utilized for barrier removal may be different than the electrolyte utilized for tungsten removal. In one embodiment, electrolyte composition provided at the third ECMP station 132 includes phosphoric or sulfuric acid and a catalyst. The electrolyte may be adapted to prevent or inhibit oxide formation on the barrier layer. The catalyst is selected to activate the Ti or other barrier layer to react selectively with a complexing agent so that the barrier layer may be removed and/or dissolved easily with minimal or no removal of copper or tungsten. The electrolyte composition may additionally include pH adjusters and clelating agents, such as amino acids, organic amines and phthalic acid or other organic carbolic acids, picolinic acid or its derivatives. The electrolyte may optionally contain abrasives. Abrasives may be desirable to remove a portion of the underlying oxide layer.

At a first barrier process step 1746, a bias voltage is provided from the power source 242 between the top surface of the pad assembly 604 and the electrode 614. The voltage is held at a constant magnitude in the range of about 1.5 to about 3.0 volts. A conductive path is established through the electrolyte filling the apertures 622 between the electrode 614 and the substrate 122 to drive an electrochemical mechanical planarizing process. The process of step 1746 generally has a titanium removal rate of about 500 to about 1000 Å/min. Removal rates for other barrier materials are comparable.

At step 1748, an endpoint of the electroprocess step 1746 is determined. The endpoint may be determined using a first metric of processing provided by the meter 240 or by the sensor 254. The current and voltage traces of the electrochemical barrier removal step 1706 are similar is form to the traces 1802, 1804 of FIG. 10, and as such, have been omitted for brevity. In one embodiment, the endpoint of step 1748 is determined by detecting a first discontinuity in current sensed by the meter 240. The first discontinuity appears when the underlying layer (typically an oxide) begins to break through the barrier layer. As the underlying oxide layer has a different resistivity than the barrier layer, the change in resistance across the processing cell is indicative of the breakthrough of the barrier layer.

In response to the endpoint detection at step 1748, a second clearance process step 1750 is performed to remove the residual tungsten layer. At step 1750, a second voltage is provided from the power source 242. The second voltage may be the same or less than the voltage of the first barrier clearance step 1746. In one embodiment, the voltage is about 1.5 to about 2.5 volts. The voltage is held at a constant magnitude and causes a current to pass through the electrolyte filling the apertures 622 between the electrode 614 and the substrate 122 to drive an electrochemical mechanical planarizing process. The process of step 1750 generally has a removal rate less than the first barrier removal step 1746 of about 300 to about 600 Å/min.

At step 1752, an endpoint of the electroprocess step 1750 is determined. The endpoint may be determined using a second metric of processing provided by the meter 240 or by the sensor 254. In one embodiment, the endpoint is determined by detecting a second discontinuity in current sensed by the meter 240. The second discontinuity appears when the ratio of area between the oxide layer is fully exposed through barrier layer that remains in the features formed in the substrate 122.

Optionally, a third clearance process step 1754 may be performed to remove any remaining debris from the barrier layer. The third clearance process step 1754 is typically a timed process, and is performed at the same or reduced voltage levels relative to the second clearance process step 1750. In one embodiment, the third clearance process step 1754 (also referred to as an overpolish step) has a duration of about 15 to about 30 seconds.

During Ecmp, voltage is the main driving force for metal polishing. For a certain voltage applied, a current (thus polish rate) of a certain magnitude is obtained for the polishing process. It was unexpectedly found however that a higher voltage might not automatically lead to an increased polishing rate. Under certain conditions, a higher applied voltage will result in a reduced rate. Rotation speed and the applied pressure, together with applied voltage will control the polishing rate by providing fast transport of reactants and products of the polishing process. As a result, it reveals the Ecmp polishing rate can be controlled by the above-mentioned parameters individually or in combination.

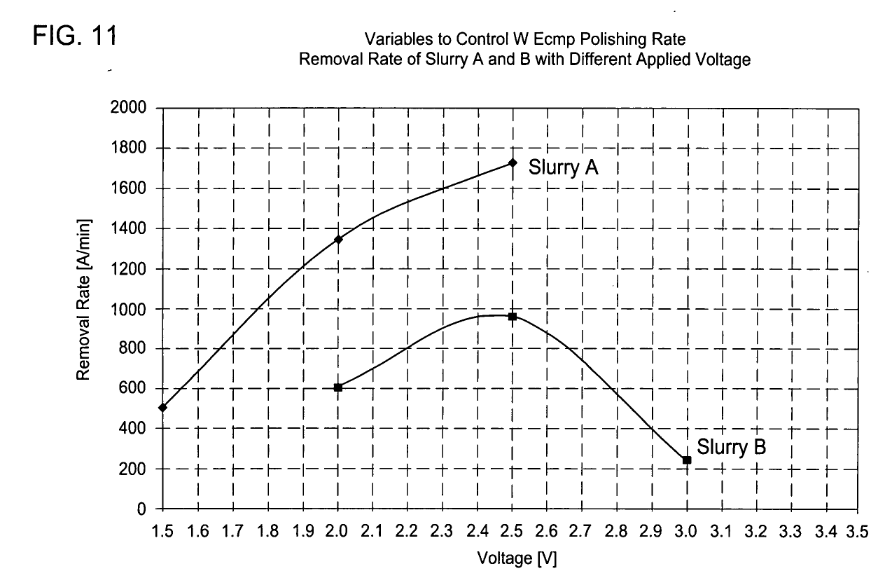

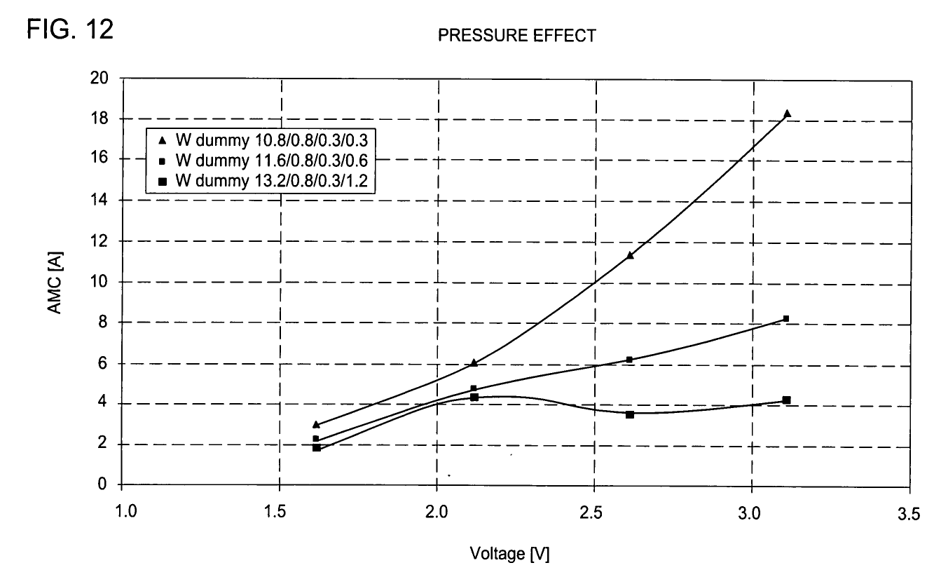

As shown in FIG. 11, for Slurry A, the removal rate increases with an increase in applied voltage. Slurry A corresponds to a slurry typically used to polish a copper layer. Slurry B, on the other hand, shows that increasing the applied voltage will actually decrease the material removal rate. Slurry B corresponds to a slurry typically used to polish a tungsten layer. The increased voltage resulting in a lower removal rate is unique to tungsten ECMP.

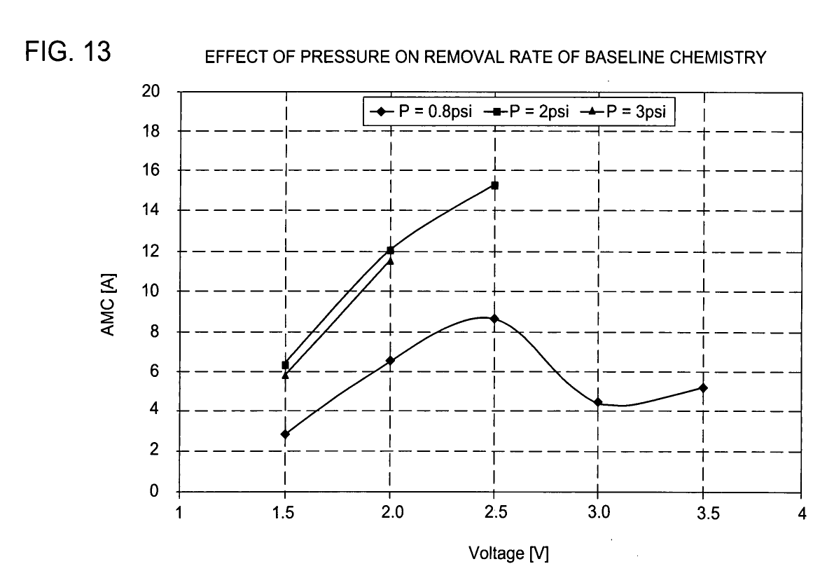

Pressure has a significant affect on the removal rate. A high pressure (i.e. a higher down force on the wafer) will result in a higher removal rate. FIGS. 12 and 13 show the effects of pressure on removal rate. At a lower pressure, the removal rate does not response to the voltage increase well. At a higher pressure the removal rate increases with increased voltage. At higher voltages, the removal rate is significant for different pressures.

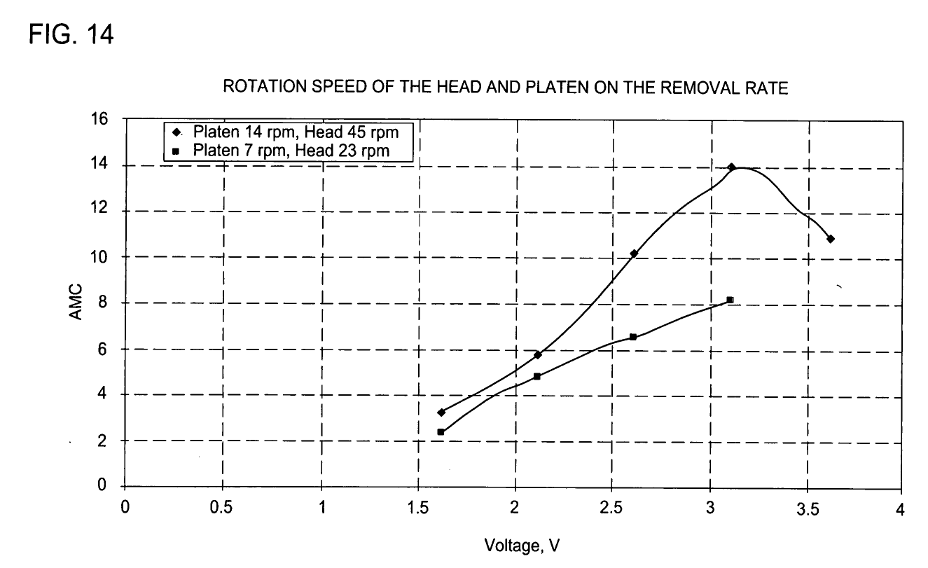

The rotation speed of the platen and polishing head also affects the removal rate. By increasing the rotation speed of both the platen and the polishing head, the removal rate will increase with increasing applied voltage. FIG. 14 shows the effects of increasing the rotation speed of both the platen and the polishing head. At a higher applied voltage, the effects of the rotation speed are even more pronounced. Combining an increase in applied voltage with an increase in rotation speed of both the platen and the polishing head leads to higher material removal rates.

First, this invention reveals that under certain conditions the Ecmp rate of W cannot be increased simply by increasing the voltage applied to the wafer. Some of the slurries studied shows that an increased voltage may lead to a reduced polishing rate. Second, this invention reveals that the rate can be unexpectedly controlled by applied voltage, applied down force (pressure on the wafer) and the relative rotation speed of the head and the platen. Thirdly, this invention reveals that to achieve a certain rate, the combination of the above parameters is necessary.

This solution may be utilized with the embodiment described above, and in other electroprocessing equipment, to process a conductive layer such as tungsten, among other metal containing materials, using processing parameters of velocity and/or pressure selected to compensate for reduced polishing rate at elevated voltages. Thus, increased polishing rate may be realized by increasing the volt (or current) in conjunction with an increase in at least one of pad to substrate contact pressure or relative velocity between the pad and substrate.

For examples, utilizing the polishing composition described above, the following results where obtained using Applied Materials' REFLEXION LK Ecmp processing system:

1. With Chemistry Described Herein:

Head speed: 11 rpm

Platen speed: 7 rpm

Pressure: 0.3 psi

Voltage: 3V

Polishing Rate: 600 A/min;

2. With Chemistry Described Herein:

Head speed: 11 rpm

Platen speed: 7 rpm

Pressure: 0.6 psi

Voltage: 3V

Polishing Rate: 1500 A/min;

3. With Chemistry Described Herein:

Head speed: 45 rpm

Platen speed: 14 rpm

Pressure: 0.3 psi

Voltage: 3V

Polishing Rate: 2000 A/min;

Thus, the present invention provides an improved apparatus and method for electrochemically planarizing a substrate. The apparatus advantageously facilitates efficient bulk and residual metal and barrier materials removal from a substrate using a single tool. Utilization of electrochemical processes for full sequence metal and barrier removal advantageously provides low erosion and dishing of conductors while minimizing oxide loss during processing. It is contemplated that a method and apparatus as described by the teachings herein may be utilized to deposit materials onto a substrate by reversing the polarity of the bias applied to the electrode and the substrate.

An exemplary polishing tool to use to practice the invention is the Applied Materials Reflexion Ecmp Full-Sequence tool. When polishing, the polishing rate can be controlled in several ways, either individually or in combination. For some slurries, particularly slurries used to polish copper, the polishing rate increases with increasing voltage to the anode. For other slurries, in particular slurries used to polish tungsten, increasing the voltage does not necessarily increase the polishing rate. In fact, for tungsten, increasing the voltage may actually decrease the polishing rate for some polishing slurries. The lower polishing rate for increased voltage suggests that there is insufficient mass transport of the reactant getting under the head and the product getting out of the head. By increasing the down force, or pressure applied, and the rotational speed, the tungsten removal rate in ECMP will increase. At a higher voltage, the increased down force (pressure applied) is even more pronounced than at lower voltage.

While the foregoing is directed to embodiments of the invention, other and further embodiments of the invention may be devised without departing from the basic scope thereof, and the scope thereof is determined by the claims that follow.

What is claimed is:

1. A method for polishing tungsten comprising:
applying a voltage to a polishing pad, wherein the polishing pad is provided on an ECMP apparatus, said apparatus comprising a platen with the polishing pad thereon;
rotating said platen and a polishing head, wherein the polishing head provides a wafer with a tungsten layer thereon;
contacting said tungsten layer with said polishing pad to create a down force pressure and a current density on said wafer while providing a polishing slurry between said polishing pad and said tungsten layer;
polishing said tungsten layer; and
controlling the rotation rate of both said platen and said polishing head by controlling said down force pressure, and by controlling said current density.

2. The method as claimed in claim 1, further comprising increasing the rotation rate of both said platen and said head, increasing said down force pressure, and increasing said applied voltage.

3. The method as claimed in claim 1, further comprising increasing the rotation rate of both said platen and said pad and increasing said current density.

4. The method as claimed in claim 1, further comprising increasing the down force pressure and increasing said current density.

5. The method as claimed in claim 1, wherein said wafer has a diameter of 300 mm and is rotated at a rotation rate of about 7-100 RPM.

6. The method as claimed in claim 5, wherein said rotation rate is about 7-14 RPM.

7. The method as claimed in claim 1, wherein said current density is about 0.01 mA/cm² to about 100 mA/cm².

8. The method as claimed in claim 1, wherein said downforce pressure applied is about 0.8 to about 3 psi.

9. The method as claimed in claim 8, wherein said downforce pressure is about 2 psi.

10. The method as claimed in claim 1, wherein said platen is rotated at about 20-100 RPM.

11. The method as claimed in claim 10, wherein said platen is rotated at about 23-45 RPM.

12. A method for polishing tungsten comprising:
providing a polishing pad on a rotatable polishing platen;
providing a rotatable polishing head;
providing a 300 mm diameter wafer on said polishing head, said wafer comprising a tungsten layer;
pressing said wafer against said polishing pad to create a downforce pressure;
rotating said platen;
rotating said polishing head;
applying a voltage to said polishing pad to create a current density on said wafer during polishing; and
controlling said polishing by controlling a rotation rate of both said pad and said wafer, controlling said current density, and controlling said downforce pressure to remove the tungsten at a rate of about 600 to about 2000 Å/min.

13. The method as claimed in claim 12, wherein said wafer has a diameter of 300 mm and is rotated at 7-100 RPM.

14. The method as claimed in claim 13, wherein said wafer is rotated at about 7-14 RPM.

15. The method as claimed in claim 12, wherein said current density is about 0.01 mA/cm² to about 100 mA/cm².

16. The method as claimed in claim 12, wherein said downforce pressure applied is about 0.8 to about 3 psi.

17. The method as claimed in claim 16, wherein said downforce pressure is about 2 psi.

18. The method as claimed in claim 12, wherein said polishing head is rotated at about 20-100 RPM.

19. The method as claimed in claim 18, wherein said polishing head is rotated at about 23-45 RPM.

20. A method for increasing a polishing rate for tungsten comprising:
providing a rotatable polishing head with a wafer comprising a tungsten thereon;
providing a rotatable platen with a polishing pad thereon;
applying a voltage to said platen; and
controlling a rotation rate of both said pad and said wafer, controlling a current density applied to said wafer, and controlling a downforce pressure between the pad and the wafer.
